(19) United States
(12) Patent Application Publication
(10) Pub. No.: US 2021/0254248 A1
(43) Pub. Date: Aug. 19, 2021

(54) STERILIZABLE POROUS FILTRATION MEDIA CONTAINING NANOFIBER

(71) Applicant: EMD Millipore Corporation, Burlington, MA (US)

(72) Inventors: Nitin Satav, Westford, MA (US); Martin Cuddy, JR., Arlington, MA (US); Xiaozhu Zhou, Bedford, MA (US); Saptarshi Chattopadhyay, Worcester, MA (US); William Trinh, Milton, MA (US); Onur Y. Kas, Waltham, MA (US); David Nhiem, Lowell, MA (US)

(21) Appl. No.: 17/167,371

(22) Filed: Feb. 4, 2021

Related U.S. Application Data
(60) Provisional application No. 62/977,884, filed on Feb. 18, 2020.

(51) Int. Cl. D04H 3/005; B01D 39/16; D01D 5/00

(52) U.S. Cl. CPC D04H 3/005; B01D 39/1623; B82Y 40/00; D01D 5/003; D01D 5/0023

(57) ABSTRACT

Provided herein are sterilizable porous filtration media and methods of making and using the same.

### CROSS-REFERENCE TO RELATED APPLICATION

The present application claims the benefit of priority of U.S. Provisional Patent Application No. 62/977,884, filed date Feb. 18, 2020, the entire content of which is incorporated herein in its entirety.

### BACKGROUND

Most filtration applications in the biopharmaceuticals industry require a sterilization step conducted by the drug manufacturer or a pre-sterilization step conducted by the filter manufacturer. Sterilization steps may include, for example, either steam-in-place or autoclave sterilization. These sterilization methods exert either high temperature or high energy into the membrane and the filtration device. Additionally, most devices sold into critical filtration applications go through 100% integrity testing, meaning every device sold will get tested at least once. Most of such integrity tests require wetting of the filtration media inside the device, followed by testing and drying. Membrane structures are required to withstand these harsh conditions in order to successfully serve in these critical filtration applications. Unfortunately, with current nanofiber-based liquid filtration membranes, membrane structure stability and performance are negatively impacted by wet/dry cycles, both with (e.g., autoclaving) and without heat (e.g., integrity testing).

### SUMMARY

Provided herein are methods and compositions related to nanofiber structures (e.g., nanofiber mats) that exhibit high permeability and retention after any wet dry process including moist heat sterilization (e.g., autoclaving, steam-in-place sterilization, and/or tyndallization).

In some aspects, provided herein are methods for producing porous, non-woven, polymeric nanofiber-containing, liquid filtration media compatible with moist heat sterilization, the methods comprising heating a porous, non-woven, nanofiber-containing liquid filtration media to at least the glass transition temperature (T_{g}) but no more than the melting temperature (Tₘ) of the nanofibers for at least the span of time needed to achieve thermal equilibrium with the heating media not including temperature ramp-up and cool down

In some aspects, provided herein are liquid filtration media compatible with moist-heat sterilization comprising, a porous, polymeric nanofiber mat that have been heated at a temperature that is at least the glass transition temperature (T_{g}) but no more than the melting temperature (Tₘ) of the polymeric nanofibers for at least the time needed for thermal equilibrium not including temperature ramp-up and cool down.

In certain aspects, provided herein are methods of sterilizing porous, non-woven, polymeric nanofiber-containing, liquid filtration media, the methods comprising heating the liquid filtration media to at least the glass transition temperature (T_{g}) but no more than the melting temperature (Tₘ) of the polymeric nanofibers for at least 1 hour, and sterilizing the heat-treated liquid filtration medium using moist heat sterilization.

In further aspects, disclosed herein are methods of removing bacteria from a liquid sample comprising heating a porous, non-woven, polymeric nanofiber-containing liquid filtration medium to at least the glass transition temperature (T_{g}) but no more than the melting temperature (Tₘ) of the polymeric nanofibers for at least 1 hour; sterilizing the liquid filtration medium using moist heat sterilization; and passing the liquid sample containing bacteria through the sterilized liquid filtration medium.

Particular aspects provided herein include methods of removing viral particles from liquid samples, said methods comprising heating a porous, non-woven, polymeric nanofiber-containing liquid filtration medium to at least the glass transition temperature (T_{g}) but no more than the melting temperature (Tₘ) of the polymeric nanofibers for at least the span of time needed to achieve thermal equilibrium; sterilizing the liquid filtration medium using moist heat sterilization; and passing the liquid sample containing the viral particles through the sterilized liquid filtration medium.

Thus, in certain aspects, provided herein are autoclavable, porous, non-woven, nanofiber, liquid filtration media prepared in accordance with the methods disclosed herein, as well as critical filtration devices for use in critical filtration applications comprising such liquid filtration media. In certain embodiments, such liquid filtration media are of particular use in sterile filtration (aseptic) applications.

In one aspect, the present invention is a method for producing a porous, non-woven, polymeric nanofiber-containing, liquid filtration medium compatible with any wet and dry process such as integrity test or moist heat sterilization, the method comprising heating the porous, non-woven, nanofiber-containing liquid filtration medium to at least the glass transition temperature (T_{g}) but no more than the melting temperature (Tₘ) of the nanofibers for at least 1 hour.

In another aspect of the present invention, the liquid filtration medium is made by electrospinning a polymer solution or melt to produce a porous, non-woven, polymeric nanofiber mat.

In another aspect of the present invention, the liquid filtration medium resists changes in liquid permeability post-sterilization relative to a corresponding filtration medium that has not been heated to at least the glass transition temperature (T_{g}) but no more than the melting temperature (Tₘ) of the nanofibers for at least 1 hour prior to sterilization.

In another aspect of the present invention, the liquid filtration medium exhibits a bubble point pressure of 5 psi to 150 psi (psig).

In another aspect of the present invention, the liquid filtration medium exhibits a bubble point of 15 psi or greater.

In another aspect of the present invention, the liquid filtration medium exhibits less change in bubble point post-sterilization compared to the same liquid filtration medium that has not been heated to at least the T_{g} but no more than the Tₘ of the polymeric nanofibers for at least 1 hour.

In another aspect of the present invention, the bubble point is measured with Galwick® as the wetting fluid.

In another aspect of the present invention, the liquid filtration medium exhibits a log reduction value (LRV) of Brevundimonas diminuta of at least 1 as measured in accordance with ASTM F838-83.

In another aspect of the present invention, the liquid filtration medium exhibits a log reduction value (LRV) of Brevundimonas diminuta of at least 4 or of at least 8 as measured in accordance with ASTM F838-83.

In another aspect of the present invention, the liquid filtration medium has a porosity from about 80% to about 95%.

In another aspect of the present invention, the liquid filtration medium exhibits a liquid permeability greater than about 1000 LMH/psi.

In another aspect of the present invention, the liquid filtration medium exhibits a liquid permeability greater than about 100 LMH/psi.

In another aspect of the present invention, the liquid filtration medium exhibits a liquid permeability greater than about 10 LMH/psi.

In another aspect of the present invention, the liquid filtration medium exhibits a higher liquid permeability post-sterilization compared to the same filtration medium that has not been heated to at least the T_{g} but no more than the Tₘ of the polymeric nanofibers for at least 1 hour.

In another aspect of the present invention, the liquid filtration medium exhibits no more than a 40% reduction in liquid permeability post-sterilization.

In another aspect of the present invention, the liquid filtration medium exhibits no more than a 30% reduction in liquid permeability post-sterilization.

In another aspect of the present invention, the liquid filtration medium exhibits no more than a 15% reduction in liquid permeability post-sterilization.

In another aspect of the present invention, the nanofibers have a fiber diameter from about 5 nm to about 1,000 nm.

In another aspect of the present invention, the liquid filtration medium comprises a 1) symmetric nanofiber mat or 2) an asymmetric nanofiber mat that exhibits a varying fiber diameter across the thickness of nanofiber mat such that the mean fiber diameter of one layer of the nanofiber mat is different than the other layers of nanofiber mat.

In another aspect of the present invention, the mean fiber diameter changes continuously from one layer of the asymmetric nanofiber mat to the other layer.

In another aspect of the present invention, the ratio of mean fiber diameter of one layer of the asymmetric nanofiber mat to the other layer is at least 1.15.

In another aspect of the present invention, the mean fiber diameter is about 5 nm to about 1,000 nm on at least one layer of the asymmetric nanofiber mat.

In another aspect of the present invention, the mean fiber diameter is about 5 nm to about 150 nm on at least one layer of the asymmetric nanofiber mat.

In another aspect of the present invention, the mean fiber diameter is about 100 nm on at least one layer of the nanofiber mat.

In another aspect of the present invention, the mean fiber diameter is about 5 nm on at least one layer of the nanofiber mat.

In another aspect of the present invention, the polymer is selected from: thermoplastic polymers, thermoset polymers, nylon, polyimide, aliphatic polyamide, aromatic polyamide, polysulfone, cellulose acetate, polyether sulfone, polyurethane, poly(urea urethane), polybenzimidazole, polyetherimide, polyacrylonitrile, poly(ethylene terephthalate), polypropylene, polyaniline, poly(ethylene oxide), poly(ethylene naphthalate), poly(butylene terephthalate), styrene butadiene rubber, polystyrene, poly(vinyl chloride), poly(vinyl alcohol), poly(vinylidene fluoride), poly(vinyl butylene) and copolymers, derivative compounds, or blends thereof.

In another aspect of the present invention, the polymer is aliphatic polyamide.

In another aspect of the present invention, the polymer is selected from: nylon-6, nylon-6,6, nylon 6,6-6,10, nylon-6 copolymers, nylon-6,6 copolymers, nylon 6,6-6,10 copolymers, and any mixture thereof.

In another aspect of the present invention, the polymer is nylon-6,6.

In another aspect of the present invention, the method comprises heating the nanofiber mat from about 1° C. to about 80° C. below Tₘ.

In another aspect of the present invention, the method comprises heating the nanofiber mat to about 56° C. below Tₘ.

In another aspect of the present invention, the method comprises heating the nanofiber mat to about 75° C. below Tₘ.

In another aspect of the present invention, the method comprises heating the nanofiber mat by about 100° C. to about 200° C. above T_{g}.

In another aspect of the present invention, the method comprises heating the nanofiber mat by about 140° C. to about 158° C. above T_{g}.

In another aspect of the present invention, the method comprises heating the nanofiber mat from about 190° C. to about 208° C.

In another aspect of the present invention, the method comprises heating the nanofiber mat to about 208° C.

In another aspect of the present invention, the method comprises heating the nanofiber mat in a non-oxidizing environment such as in an inert atmosphere oven.

In another aspect of the present invention, the method comprises heating the nanofiber mat for at least about 1 hour to at least about 24 hours.

In another aspect of the present invention, the method comprises heating the filtration medium for at least about 12 hours.

In another aspect of the present invention, the method comprises any wet and dry process such as integrity testing, moist heat sterilization comprises autoclaving, steam-in-place sterilization, and/or tyndallization.

In another aspect of the present invention, the porous, non-woven, nanofiber-containing, liquid filtration medium is electrospun onto a surface of the porous or non-porous support.

In another aspect of the present invention, the nanofiber mat is electrospun onto a surface of the porous or non-porous support, wherein the root mean square height of the surface of the porous non-woven support is less than about 70 μm.

In another aspect of the present invention, the support comprises one or more layers produced by melt-blowing, wet-laying, spin-bonding, calendaring, electrospinning, electro-blowing or any combination thereof.

In another aspect of the present invention, the support comprises thermoplastic polymers, polyolefins, polypropylene, polyesters, polyamides, copolymers, polymer blends, cellulose based and combination thereof.

In another aspect of the present invention, the tightest pore diameter of the nanofiber layer is smaller than the tightest pore diameter of the porous non-woven support.

In another aspect of the present invention, the porous support comprises one or more layers selected from the group consisting of spunbonded nonwovens, meltblown nonwovens, needle punched nonwovens, spunlaced nonwovens, wet laid nonwovens, resin-bonded nonwovens, electrospun nonwoven, electro-blown nonwoven, woven fabrics, knit fabrics, paper, and combinations thereof.

In another aspect, the present invention relates to an autoclavable, porous, non-woven, nanofiber, liquid filtration medium prepared in accordance with the methods of the present invention.

In one aspect, the present invention is a liquid filtration medium compatible with any wet and dry process such as integrity test or moist-heat sterilization comprising, a porous, polymeric nanofiber mat that has been heated at a temperature that is at least the glass transition temperature (T_{g}) but no more than the melting temperature (Tₘ) of the polymeric nanofibers for at least 1 hour.

In another aspect of the present invention, the liquid filtration medium is made by electrospinning a polymer solution or melt to produce a porous, non-woven, polymeric nanofiber mat.

In another aspect of the present invention, the liquid filtration medium is resistant to changes in liquid permeability post-sterilization relative to a corresponding filtration medium comprising a nanofiber mat that has not been heated to at least the T_{g} but no more than the Tₘ of the polymeric nanofibers for at least 1 hour.

In another aspect of the present invention, the liquid filtration medium exhibits a bubble point pressure of 5 psi to 150 psi.

In another aspect of the present invention, the liquid filtration medium exhibits a bubble point of 15 psi or greater.

In another aspect of the present invention, the liquid filtration medium exhibits less change in bubble point post-sterilization compared to the same liquid filtration medium comprising a nanofiber mat that has not been heated to at least the T_{g} but no more than the Tₘ of the polymeric nanofibers for at least 1 hour.

In another aspect of the present invention, the bubble point is measured with Galwick® as wetting fluid.

In another aspect of the present invention, the liquid filtration medium exhibits a log reduction value (LRV) of Brevundimonas diminuta of at least 1 as measured in accordance with ASTM F838-83.

In another aspect of the present invention, the liquid filtration medium exhibits a log reduction value (LRV) of Brevundimonas diminuta of at least 4 as measured in accordance with ASTM F838-83.

In another aspect of the present invention, the liquid filtration medium exhibits a log reduction value (LRV) of Brevundimonas diminuta of at least 8 as measured in accordance with ASTM F838-83.

In another aspect of the present invention, the liquid filtration medium has a porosity from about 80% to about 95%.

In another aspect of the present invention, the liquid filtration medium exhibits a liquid permeability greater than about 1000 LMH/psi following moist heat sterilization.

In another aspect of the present invention, the liquid filtration medium exhibits a liquid permeability greater than about 100 LMH/psi following moist heat sterilization.

In another aspect of the present invention, the liquid filtration medium exhibits a liquid permeability greater than about 10 LMH/psi following moist heat sterilization.

In another aspect of the present invention, the liquid filtration medium exhibits a higher liquid permeability post-sterilization relative to a corresponding liquid filtration medium comprising a nanofiber mat that has not been heated to at least the T_{g} but no more than the Tₘ of the polymeric nanofibers for at least 1 hour.

In another aspect of the present invention, the liquid filtration medium exhibits no more than a 40% reduction in liquid permeability following moist heat sterilization.

In another aspect of the present invention, the liquid filtration medium exhibits no more than a 30% reduction in liquid permeability following moist heat sterilization.

In another aspect of the present invention, the liquid filtration medium exhibits no more than a 15% reduction in liquid permeability following moist heat sterilization.

In another aspect of the present invention, the liquid filtration medium exhibits no significant changes in liquid permeability following moist heat sterilization.

In another aspect of the liquid filtration medium, the nanofiber mat of the liquid filtration medium comprises a fiber diameter from about 5 nm to about 1,000 nm.

In another aspect of the liquid filtration medium, the liquid filtration medium comprises 1) asymmetric nanofiber mat or 2) an asymmetric nanofiber mat that exhibits a varying fiber diameter across the thickness of nanofiber mat such that the mean fiber diameter of one layer of the nanofiber mat is different than the other layers of nanofiber mat

In another aspect of the liquid filtration medium, the mean fiber diameter changes continuously from one layer of the nanofiber mat to the other layer.

In another aspect of the liquid filtration medium, the ratio of mean fiber diameter of one layer of the nanofiber mat to another layer is at least 1.15.

In another aspect of the liquid filtration medium, the mean fiber diameter is about 5 nm to about 1,000 nm on at least one layer of the nanofiber mat.

In another aspect of the liquid filtration medium, the mean fiber diameter is about 5 nm to about 100 nm on at least one layer of the nanofiber mat.

In another aspect of the liquid filtration medium, the mean fiber diameter is about 100 nm on at least one layer of the nanofiber mat.

In another aspect of the liquid filtration medium, the mean fiber diameter is about 5 nm on at least one layer of the nanofiber mat.

In another aspect of the liquid filtration medium, the polymer is selected from: thermoplastic polymers, thermoset polymers, nylon, polyimide, aliphatic polyamide, aromatic polyamide, polysulfone, cellulose acetate, polyether sulfone, polyurethane, poly(urea urethane), polybenzimidazole, polyetherimide, polyacrylonitrile, poly(ethylene terephthalate), polypropylene, polyaniline, poly(ethylene oxide), poly(ethylene naphthalate), poly(butylene terephthalate), styrene butadiene rubber, polystyrene, poly(vinyl chloride), poly(vinyl alcohol), poly(vinylidene fluoride), poly(vinyl butylene) and copolymers, derivative compounds, or blends thereof.

In another aspect of the liquid filtration medium, the polymer is aliphatic polyamide.

In another aspect of the liquid filtration medium, the polymer is selected from: nylon-6, nylon-6,6, nylon 6,6-6,10, nylon-6 copolymers, nylon-6,6 copolymers, nylon 6,6-6,10 copolymers, and any mixture thereof.

In another aspect of the liquid filtration medium, the polymer is nylon-6,6.

In another aspect, the nanofiber mat has been heated to about 1° C. to about 80° C. below Tₘ.

In another aspect of the liquid filtration medium of the invention, the nanofiber mat has been heated to about 56° C. below Tₘ.

In another aspect of the liquid filtration medium of the invention, the nanofiber mat has been heated to about 75° C. below Tₘ.

In another aspect of the liquid filtration medium of the invention, the nanofiber mat has been heated to about 100° C. to about 200° C. above T_{g}.

In another aspect of the liquid filtration medium of the invention, the nanofiber mat has been heated to about 140° C. to about 158° C. above T_{g}.

In another aspect of the liquid filtration medium of the invention, the nanofiber mat has been heated to about 190° C. to about 208° C.

In another aspect of the liquid filtration medium of the invention, the nanofiber mat has been heated to about 208° C.

In another aspect of the liquid filtration medium of the invention, the nanofiber mat has been heated in a non-oxidizing environment such as an inert atmosphere oven.

In another aspect of the liquid filtration medium of the invention, the nanofiber mat has been heated for at least about 1 hour to at least about 24 hours.

In another aspect of the liquid filtration medium of the invention, the nanofiber mat has been heated for at least about 12 hours.

In another aspect of the liquid filtration medium of the invention, wet and dry process such integrity testing, moist heat sterilization comprises autoclaving, steam-in-place sterilization, and/or tyndallization.

In another aspect of the liquid filtration medium of the invention, the porous, non-woven, nanofiber-containing, liquid filtration medium is electrospun onto a surface of the porous or non-porous support.

In another aspect of the liquid filtration medium of the invention, the nanofiber mat is electrospun onto a surface of the porous or non-porous support, wherein the root mean square height of the surface of the porous non-woven support is less than about 70 μm.

In another aspect of the liquid filtration medium of the invention, the support comprises one or more layers produced by melt-blowing, wet-laying, spin-bonding, calendaring, electrospinning, electro-blowing or any combination thereof.

In another aspect of the liquid filtration medium of the invention, the support comprises thermoplastic polymers, polyolefins, polypropylene, polyesters, polyamides, copolymers, polymer blends, cellulose based and combination thereof.

In another aspect of the liquid filtration medium of the invention, the tightest pore size of the nanofiber layer is smaller than the tightest pore size of the porous non-woven support.

In another aspect of the liquid filtration medium of the invention, the porous support comprises one or more layers selected from the group consisting of spunbonded nonwovens, meltblown nonwovens, needle punched nonwovens, spunlaced nonwovens, wet laid nonwovens, resin-bonded nonwovens, electrospun nonwoven, electro-blown nonwoven, woven fabrics, knit fabrics, paper, and combinations thereof.

In another aspect, the present invention comprises an autoclavable, porous, non-woven, nanofiber, liquid filtration medium prepared in accordance with the methods of the present invention.

In another aspect, the present invention comprises a filtration device for use in critical filtration comprising one or more layers of porous composite media of the present invention.

On one aspect, the present invention comprises a porous composite media comprising: a porous asymmetric flat sheet membrane prefilter having a tight layer and an open layer and a pore size increasing in size between the tight layer and the open layer, and a retentive layer comprising the liquid filtration medium of any one of claims 48 to 97 located on the tight layer of the porous asymmetric flat sheet membrane, wherein the pore size of the retentive layer is smaller than the pore size of the tight layer of the porous asymmetric flat sheet membrane prefilter.

In another aspect, the porous composite media has a bubble point, as measured with a liquid, which is at least 20% greater than the bubble point of the porous flat sheet membrane prefilter alone.

In another aspect, the porous composite media has a mean flow pressure for isopropanol ranging from about 10 psi to about 130 psi.

In another aspect, the porous composite media has a porous asymmetric polymer flat sheet membrane comprising one or more layers produced by solution phase inversion, thermally initiated phase separation, vapor induced phase separation, track etching, biaxial stretching, solvent etching, and combinations thereof.

In another aspect, the present invention relates to a filtration device for use in critical filtration comprising the porous composite media of the present invention

In another aspect, the filtration device has the composite filtration media positioned in the device such that the porous asymmetric polymer flat sheet membrane is upstream, in the direction of filtration, of the retentive filter layer, whereby the porous asymmetric flat sheet membrane provides prefiltration of said sample and the retentive filter layer provides further filtration of a sample.

In one aspect, the present invention relates to a method of sterilizing a porous, non-woven, polymeric nanofiber-containing, liquid filtration medium, the method comprising heating the liquid filtration medium to at least the glass transition temperature (T_{g}) but no more than the melting temperature (Tₘ) of the polymeric nanofibers for at least 1 hour and sterilizing the heat-treated liquid filtration medium using moist heat sterilization.

In one aspect, the present invention relates to a method of removing bacteria from a liquid sample comprising heating a porous, non-woven, polymeric nanofiber-containing liquid filtration medium to at least the glass transition temperature (T_{g}) but no more than the melting temperature (Tₘ) of the polymeric nanofibers for at least 1 hour; sterilizing the liquid filtration medium using moist heat sterilization; and passing the liquid sample containing bacteria through the sterilized liquid filtration medium.

In one aspect, the present invention relates to a method of removing viral particles from a liquid sample comprising heating a porous, non-woven, polymeric nanofiber-containing liquid filtration medium to at least the glass transition temperature (T_{g}) but no more than the melting temperature (Tₘ) of the polymeric nanofibers for at least 1 hour; sterilizing the liquid filtration medium using moist heat sterilization; and passing the liquid sample containing the viral particles through the sterilized liquid filtration medium.

In another aspect of the present invention, the liquid filtration medium exhibits a virus log reduction value (LRV) greater than about 6.

In another aspect of the present invention, the liquid filtration medium exhibits a virus log reduction value (LRV) greater than about 3.

In another aspect of the present invention, the liquid filtration medium exhibits a virus log reduction value (LRV) greater than about 2.

### BRIEF DESCRIPTION OF THE DRAWINGS

FIG. 1 illustrates the difference in water permeability of selected nanofiber media before and after a sterilization process, either without a pre-sterilization heat treatment (left) or with a pre-sterilization heat treatment (right). The hatched bar label shows percent (%) drop in water permeability post sterilization. Sterilization conditions are three cycles of autoclave, each cycle is 135° C. for 60 min followed by 15 min dry time.

FIG. 2 is a graph depicting main effect plot for percent loss in water permeability. Each point shows average percent loss for each factor either without a pre-sterilization heat treatment (left) or with a pre-sterilization heat treatment (right).

FIG. 3 shows representative Scanning Electron Microscope (SEM) images demonstrating the morphology of selected nanofiber media before and after a sterilization process either without a pre-sterilization heat treatment (top) or with a pre-sterilization heat treatment (bottom).

FIG. 4 shows water permeability remains unchanged in heat-treated asymmetric Nylon-66 (N66) nanofiber mats following as many as twelve autoclave cycles. Notably, mat bubble point (BP) increases after the first three autoclave cycles (AC-3×) and remain consistent during additional autoclave cycles. Such mats were measured fully retentive to bacteria at BP of 15 psi.

FIG. 5 presents representative Scanning Electron Microscope (SEM) images that show that multiple autoclave cycles do not substantially alter the morphology of nanofibers in heat-treated, asymmetric, nylon-66 media (a) prior to sterilization, (b) after three autoclave cycles, (c) after nine autoclave cycles, and (d) after twelve autoclave cycles. The fiber diameter ranged within 95-105 nm for all conditions.

### DETAILED DESCRIPTION

General

Typically, porous filtration media are sterilized prior to their aseptic application as part of the guidelines set forth by the International Council for Harmonization of Technical Requirements for Pharmaceuticals for Human Use (ICH). Of all the methods available for sterilization of porous filtration media for aseptic applications, moist heat, in the form of saturated steam under pressure (steam-in-place sterilization) or autoclave sterilization, is the most widely used. Steam (moist heat) sterilization is nontoxic, inexpensive, rapidly microbicidal, sporicidal, and is the preferred sterilization method for aseptic applications. However, such sterilization methods may negatively impact filtration properties of the media critical to the aseptic application. Nanofiber-based liquid filtration membranes (e.g., mats) that are not subjected to steam sterilization can demonstrate high liquid permeability and retention of microorganisms. However, as demonstrated herein, the morphology of nanofiber-based liquid filtration membranes can be altered when subjected to wet-dry processes including conventional steam sterilization processes, potentially resulting in a dramatic loss-in water permeability. It is therefore essential to design a porous filtration media that is robust and can withstand wet-dry process at room temperature (such as used in integrity test), steam sterilization protocols as well as dry sterilization protocols (e.g., gamma irradiation).

Without being bound by any particular theory, collapse of the nanofiber mats may occur during a drying process after a wetting agent (e.g., water or water and/or alcohol) fills the void space of the porous nanofiber mat, either during integrity testing (prior to autoclave sterilization process) or by intrusion into the mat by steam condensation during the autoclave process. An autoclave sterilization cycle typically includes a post-sterilization drying step that occurs with temperature ramp down. During such a drying step the liquid level within the pores of the nanofiber mat recede rapidly and the surface tension (Laplace forces) of the receding liquid level pulls the nanofibers together, resulting in a three-dimensional collapse of the porous structure, predominantly across the thickness of the mat (in the direction of liquid evaporation). The three-dimensional collapse compresses the mat and decreases porosity, resulting in a loss of water permeability. Loss is greater in nanofiber mats comprising a smaller effective pore diameter (i.e., mats having thinner nanofibers) as opposed to mats comprising a larger pore diameter (wherein the nanofibers have a larger diameter). Thus, the impact of wet and dry processes including moist heat sterilization is particularly critical for filtration media comprising thinner nanofibers and for applications which require higher retention assurance.

In certain embodiments, the filtration media and nanofiber mats disclosed herein counter structural collapse by affecting the mechanical modulus of the nanofiber, as defined by the polymer molecular weight, orientation, and crystallinity of said nanofibers. Such strategies to increase the robustness of a nanofiber media and improve its ability to resist changes in water permeability, post-sterilization can include, for example, process modification, material selection, and/or structural design. For Example, in some embodiments, post-autoclaving effects may be mitigated by a combination of heat treatment, selection of an appropriate nanofiber polymer, and/or use of an asymmetric filter structure.

Thus, in certain aspects, the methods and filtration media disclosed herein have implications in the biopharmaceutical industry in particular. In certain aspects, provided herein are methods that can be used with as-spun porous filtration media to produce filter media sufficiently robust to withstand wet-dry processes including steam sterilization protocols (e.g., autoclaving), and, in doing so, decrease processing time and cost of particular aseptic filtration processes. In some aspects, the methods provided herein can be used to make nanofiber structures that resist collapse (e.g., retain structural integrity) following moist heat sterilization.

### Definitions

For convenience, certain terms employed in the specification, examples, and appended claims are collected here.

As used herein, the singular forms “a,” “an” and “the” are intended to include the plural forms as well, unless the context clearly indicates otherwise.

The term “about” means within an acceptable error range for the particular value as determined by one of ordinary skill in the art. As used herein, “about” refers to an amount that is within 10% of a given value. In other words, these values include the stated value with a variation of 0-10% around the value (X±10%).

An “asymmetric” arrangement of nanofibers or an “asymmetric nanofiber mat” may mean that the average diameter of the nanofibers on one layer of the filtration media (e.g., the fibrous mat or support) differs appreciably from the average diameter of the nanofibers on the other layer of the filtration media; or characterized by varying fiber diameter across the thickness of nanofiber mat such that the mean fiber diameter of one layer of the nanofiber mat is different than the other layers of nanofiber mat. The gradient of fiber diameter across the thickness or cross section of the nanofiber mat can be also described by an ‘hour-glass’ structure or characterized by having an asymmetry in which the fiber diameter across the thickness of nanofiber mat varies such that the mean fiber diameter of one layer of the nanofiber mat is different than the other layers of nanofiber mat. For example, the nanofiber mat can be in the form of a sheet having at least two layers (e.g., a composite filtration media such as a composite nanofiber mat) wherein one layer (i.e. the “top layer”) is disposed on the top face of the sheet, another layer (i.e., the “bottom layer”) is disposed on the bottom face of the sheet, and optionally one or more additional layers (i.e., “middle layers”) are disposed between the top and bottom layers of the nanofiber mat, wherein the nanofibers comprising at least one of the layers has an average fiber diameter which is different from the average fiber diameter of the nanofibers of another layer. “Asymmetric” filtration media (e.g., nanofiber mats) also include structures in which the average diameter of the nanofibers, increase continuously from one surface of the media to the other surface (sometimes referred to as the “tight” layer and “open” layer, respectively). For example, filtration media, including nanofiber mats, of the present invention can be formed by simultaneously or sequentially forming nanofibers of two or more different average fiber diameters into a non-woven structure. By varying the relative rates at which the different nanofibers are formed, an asymmetric structure can be prepared in which the fiber diameter changes continuously from one surface to the opposing surface. The rate of change of the average fiber diameter through the thickness of the fiber support can be “slow” or relatively abrupt. It will be recognized that the term “layer” refers to a region of the media in which the average fiber diameter is relatively constant but need not be sharply defined. In an alternative embodiment, an asymmetric arrangement of nanofibers comprises nanofibers of the same average fiber diameter at different packing densities within the filtration media. For example, the layers of composite filtration media (e.g., composite nanofiber mat) can be prepared from nanofibers of essentially the same average fiber diameter, except that the percentage of the total volume of each layer occupied by the nanofibers can differ. See, for example U.S. Pat. Nos. 4,261,834 and 4,629,563, incorporated herein by reference in their entirety.

The term “electrospinning” or “electrospun”, as used herein, refers to an electrostatic spinning process of producing nanofibers from a polymer solution or suspension or melt by applying an electric potential to such solution. The electrostatic spinning process for making an electrospun nanofiber mat for a filtration medium, including a suitable apparatus for performing the electrostatic spinning process is disclosed in International Publication Nos. WO 2005/024101, WO 2006/131081, and WO 2008/106903, each fully incorporated herein by reference, and each assigned to Elmarco of Liberec, Czech Republic. “Electroblowing” describes an electrostatic spinning process wherein the polymer solution discharged from the spinning nozzle is blown with a blowing gas discharged from a gas injection nozzle to form a fibrous web of fibers.

The term “filtrate” or “permeate,” as used interchangeably herein, refers to the solution that crosses a filter or membrane, e.g., an electrospun nanofiber composition used herein, as well as the solution that has already crossed a filter or membrane.

The terms “including,” “includes,” “having,” “has,” “with,” or variants thereof are inclusive in a manner similar to the term “comprising.” The phrases “consisting essentially of” or “consists essentially of” encompass embodiments containing the specified materials or steps and those including materials and steps that do not materially affect the basic and novel characteristic(s) of the embodiments.

The term “Logarithmic Reduction Value,” or “LRV,” as used herein, refers to a common logarithm (base 10) of the ratio of particle concentration in the feed to that in filtrate, measured under standardized conditions.

“Bubble Point Test” provides a convenient way to measure effective pore size. It is calculated from the following equation:

$$P = \frac{2 γ}{r} cos θ$$

Where P is the bubble point pressure, γ is the surface tension of the probe fluid, r is the pore radius and θ is the liquid-solid contact angle. The maximum pore size (or first bubble point) is recorded when gas flow through the sample is detected, the mean flow pore size corresponds to the pore size calculated at the pressure where the wet curve and the half dry curve meet (it corresponds at the pore size at which 50% of the total gas flow can be accounted).

Membrane manufacturers assign nominal pore size ratings to commercial membrane filters, which are based on their retention characteristics. When reported herein, maximum pore size is determined by bubble point test as set forth in ASTM Designation F316-03, “Standard Test Methods for Pore Size Characteristic of Membrane Filters by Bubble Point and Mean Flow Pore Test”, as reapproved in 2011, and is reported in nanometers (nm). Unless otherwise stated, all BP are measured with Galwick® (Porous Materials Incorporated, Ithaca, N.Y.) as the wetting fluid.

The term “nanofiber” as used herein refers to fibers having an average diameter or cross-section less than 1000 nm. In some embodiment, nanofibers disclosed herein have a number average cross section of less than 800 nm, less than 700 nm, less than 600 nm, less than 500 nm, less than 400 nm, or less than 200 nm. In certain embodiments, the nanofibers disclosed herein have a number average diameter of at least 5 nm, at least 20 nm, at least 30 nm, at least 40 nm, or at least 50 nm. In certain embodiments the nanofibers disclosed herein have a number average diameter of between 5 nm and 500 nm, between 5 nm and 200 nm, between 5 nm and 100 nm, between 5 nm and 50 nm, between 50 nm and 500 nm, or between 50 nm and 200 nm. The term diameter as used herein includes the greatest cross-section of non-round shapes.

The term “nanofiber mat” as used herein, refers to an assembly of multiple nanofibers, such that the thickness of the mat is typically at least about 10 times greater than the diameter of a single fiber in the mat. The nanofibers can be arranged randomly in the mat or aligned along one or multiple axes.

The term “nonwoven” means a web including a multitude of randomly distributed fibers. The fibers generally can be bonded to each other or can be unbonded. The fibers can be staple fibers or continuous fibers. The fibers can comprise a single material or a multitude of materials, either as a combination of different fibers or as a combination of similar fibers each comprised of different materials.

As used herein, the term “permeability” refers to the rate at which a volume of fluid passes through a filtration medium of a given area at a given pressure drop across the filter. Common units of permeability are liters per square meter per hour for each psi of pressure drop, abbreviated as LMH/psi. Such measurements are taken by passing deionized water through said filter medium samples having a given area. The water is forced through the samples using hydraulic pressure (water head pressure) or pneumatic pressure (air pressure over water).

The term “polymer” or “polymeric” refers to a relatively high molecular weight organic compound, natural or synthetic, whose structure can be represented by a repeated small unit, the monomer (e.g., nylon, polyethylene, rubber, cellulose). Natural biopolymers such as DNA and proteins are fundamental to biological structure and function. Synthetic polymers are typically formed by addition or condensation polymerization of monomers. Nylon-6 is referred to herein as nylon-6 or N6. N66 is referred to interchangeably as N6,6, N6/6 or N66.

The term “porosity” is used herein to express the extent of empty spaces in a material and is a fraction of the volume of empty space over the total volume. Percentage porosity is calculated based on the following equation: % Porosity=100×[1−(basis weight/(mat thickness×polymer density))], where the unit for basis weight is g/m², the unit for polymer density is g/m³, and the unit for mat thickness is m.

The term “retentate,” as used herein, refers to the component or portion of the solution that is retained and does not cross a filter or membrane, e.g., a electrospun nanofiber composition used herein, as well as that which has not yet crossed a filter or membrane. In case a Stirred Cell is employed, the liquid with solute that remains on the upstream layer of the filter or membrane in a Stirred Cell is referred to as the retentate. In case of a TFF cassette or spiral device, the liquid which flows through the feed/retentate channels of a cassette or spiral device and returns from the device back to the feed tank is referred to as the retentate.

As used herein, a “semi-crystalline” polymer refers to a polymer comprising a multiphase structure, i.e., an amorphous phase and a crystalline fraction with identical chemical compositions but divergent physical properties, when present in the solid state. When heated, such polymers usually exhibit a glass transition temperature (T_{g}) in the amorphous phase and a melting point temperature (Tₘ) in the crystalline phase; whereas amorphous polymers have only a T_{g} and no Tₘ.

The terms “variation” and “coefficient of variation” are used interchangeably herein and refer to a standardized measure of dispersion of a probability distribution or frequency distribution. It is often expressed as a percentage and is defined as the ratio of the standard deviation to the mean.

Methods of Producing Sterilizable Non-Woven Nanofiber Structures

In certain aspects, provided herein are methods for producing porous, non-woven, polymeric nanofiber-containing, liquid filtration media compatible with moist heat sterilization. In certain embodiments, such methods include upgrading “as-spun” nanofiber structures, as are known in the art, to moist heat sterilizable forms by using a unique combination of parameters, including, for example, precise heat treatment, polymer selection, and/or specific nanofiber structure. Likewise, in certain aspects, provided herein are liquid filtration medium compatible with moist-heat sterilization comprising a porous, polymeric nanofiber mat disclosed herein (e.g., prepared by any of the methods disclosed herein).

In some embodiments, the porous, non-woven, polymeric nanofiber-containing liquid filtration media (or at least a nanofiber mat comprising said filtration media) undergo heat treatment, in which they are heated to at least the glass transition temperature (T_{g}) but no more than the melting temperature (Tₘ) of the polymeric nanofibers (e.g., nanofibers comprising one or more polymers). Such heat-treatment, as is described herein, is preferably carried out in a non-oxidizing atmosphere. For example, the heat treatment may be carried out in an anaerobic or inert atmosphere oven, or the like, as are known in the art. Transition and melting temperatures of certain exemplary polymers are provided in Table 1 and known in the art. In cases where glass transition temperatures or melting temperatures are provided as a range, for purposes herein the midpoint of the range shall be treated as the respective temperature.

TABLE 1
Glass transition and melting temperatures of exemplary polymers

| | Transition | Melting |
|---|---|---|
| Polymer | temperature (T_{g}) | temperature (Tₘ) |
| Polyethylene (high density) | −125° C. | 130° to 140° C. |
| Polyethylene (low density) | −130° C. | 85° to 125° C. |
| Polytetrafluoroethylene (PTFE) | 120° to 130° C. | 320° to 330° C. |
| Polyethylene Terephthalate (PET) | 70° to 80° C. | 245° to 265° C. |
| Nylon 6 | 40° to 60° C. | 210° to 220° C. |
| Nylon 6/6 | 50° to 60° C. | 240° to 265° C. |
| Nylon 6/10 | 45° to 55° C. | 215° to 220° C. |
| Polyphenylene Sulfide | 85° to 95° C. | 275° to 290° C. |
| Polypropylene | −20° to −5° C. | 165° to 175° C. |
| Polyvinylidene Fluoride | −30° to −20° C. | 155° to 185° C. |

In certain embodiments, the liquid filtration medium (e.g., as-spun nanofiber mat) is heated to a temperature below the Tₘ of the polymeric nanofibers in the medium. In some embodiments, the liquid filtration medium is heated from about 1° C. to about 80° C. below the Tₘ of the polymeric nanofibers. In certain embodiments, the liquid filtration medium is heated to a temperature that is about 1° C., about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., or about 80° C. below the Tₘ of the polymeric nanofibers. In some such embodiments, the liquid filtration medium may be heated from about 5° C. to about 15° C., from about 10° C. to about 20° C., from about 15° C. to about 25° C., from about 20° C. to about 30° C., from about 25° C. to about 35° C., from about 30° C. to about 40° C., from about 35° C. to about 45° C., from about 40° C. to about 50° C., from about 45° C. to about 55° C., from about 50° C. to about 60° C., from about 55° C. to about 65° C., from about 60° C. to about 70° C., from about 65° C. to about 75° C., or from about 70° C. to about 80° C. below the Tₘ of the polymeric nanofibers. In some embodiments, the liquid filtration medium is heated to about 56° C. below the Tₘ of the polymeric nanofibers. In certain embodiments, the liquid filtration medium is heated to about 75° C. below the Tₘ of the polymeric nanofibers.

In some embodiments, the liquid filtration media comprising polymeric nanofibers disclosed herein (or at least the nanofiber mat comprising said filtration media) heated to a temperature that is above the T_{g} of the polymeric nanofibers in the media. In certain embodiments, the liquid filtration media is to a temperature that is about 100° C. to about 200° C. above the T_{g} of the polymeric nanofibers. In some embodiments, the liquid filtration medium is heated that is about 100° C., about 105° C., about 110° C., about 115° C., about 120° C., about 125° C., about 130° C., about 135° C., about 140° C., about 145° C., about 150° C., about 155° C., about 160° C., about 165° C., about 170° C., about 175° C., about 180° C., about 185° C., about 190° C., about 195° C., or by about 200° C. above the T_{g} of the polymeric nanofibers. In some such embodiments, the liquid filtration medium is heated to a temperature that is about 100° C. to about 110° C., about 105° C. to about 115° C., about 110° C. to about 120° C., about 115° C. to about 125° C., about 120° C. to about 130° C., about 125° C. to about 135° C., about 130° C. to about 140° C., about 135° C. to about 145° C., about 140° C. to about 150° C., about 145° C. to about 155° C., about 150° C. to about 160° C., about 155° C. to about 165° C., about 160° C. to about 170° C., about 165° C. to about 175° C., about 170° C. to about 180° C., about 175° C. to about 185° C., about 180° C. to about 190° C., about 185° C. to about 195° C., or by about 190° C. to about 200° C. above the T_{g} of the polymeric nanofibers. In certain embodiments the liquid filtration media (e.g., polymeric nanofibers) is heated by about 140° C. to about 158° C. above the T_{g} of the polymeric nanofibers.

In some embodiments, the liquid filtration media comprises Nylon 6/6 polymeric nanofibers and is heated to a temperature that is about 190° C. to about 210° C. (e.g., for at least 1 hour). In some embodiments, the liquid filtration media comprising Nylon 6/6 polymeric nanofibers is heated to a temperature of about 208° C. (e.g., for at least 1 hour).

In certain embodiments, the nanofiber media is heat treated for at least 1 hour, at least 2 hours, at least 3 hours, at least 4 hour, at least 5 hours, at least 6 hours, at least 7 hours, at least 8 hours, at least 9 hours, at least 10 hours, at least 11 hours, at least 12 hours, at least 13 hours, at least 14 hours, at least 15 hours, at least 16 hours, at least 17 hours, at least 18 hours, at least 19 hours, at least 20 hours, at least 21 hours, at least 22 hours, at least 23 hours, or at least 24 hours. In some embodiments, the nanofiber media is heat treated for no more than 2 days, no more than 36 hours, no more than 24 hours, no more than 23 hours, no more than 22 hours, no more than 21 hours, no more than 20 hours, no more than 19 hours, no more than 18 hours, no more than 17 hours, no more than 16 hours, no more than 15 hours, no more than 14 hours, no more than 13 hours, no more than 12 hours, no more than 11 hours, no more than 10 hours, no more than 9 hours, no more than 8 hours, no more than 7 hours, no more than 6 hours, no more than 5 hours, or no more than 1 hour. In certain embodiments, the nanofiber media is heat treated for about 1 hour, about 2 hours, about 3 hours, about 1 hour, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, or about 24 hours. In certain embodiments, the nanofiber media is heat treated for 1 hour to 21 hours, 1 hour to 18 hours, 1 hour to 12 hours, or 1 hour to 6 hours.

In some embodiments, the liquid filtration media disclosed herein composed of an asymmetric nanofiber mat that exhibits a varying fiber diameter across the thickness of nanofiber mat such that the mean fiber diameter of one layer of the nanofiber mat is different than the other layers of nanofiber mat. Alternatively, the asymmetric nanofiber structure may be a composite multilayer structure, the layer(s) of one layer having a mean fiber diameter different than layer(s) of the other layer. The layers on the two “external” surfaces having a mean fiber diameter different than the “internal” layer(s). The ‘external’ surfaces are defined as one which is in contact with the spinning substrate or facing the electrode generating nanofiber. Everything in between the two external surfaces is defined as internal layers. In certain embodiments, the ratio of mean fiber diameter of one layer of the asymmetric nanofiber mat to the other layer is at least 1 to 2. In some embodiments said ratio of mean fiber diameter is at least 1 to 1.75, 1 to 1.5, 1 to 1.25, or 1 to 1.15. Thus, in certain embodiments, the ratio of mean fiber diameter of one layer of the asymmetric nanofiber mat to the other layer is at least 1.15.

The asymmetric nanofiber structures disclosed herein, may have a mean fiber diameter of about 5 nm to about 1,000 nm on at least one layer. Accordingly, the asymmetric nanofiber structure may have a nanofiber diameter of about 1000 nm, 950 nm, 900 nm, 850 nm, 800 nm, 750 nm, 700 nm, 650 nm, 600 nm, 550 nm, 500 nm, 450 nm, 400 nm, 350 nm, 300 nm, 250 nm, 200 nm, 150 nm, 100 nm, 90 nm, 80 nm, 70 nm, 60 nm, 50 nm, 40 nm, 30 nm, or 20 nm on at least on layer. In some embodiments, the average nanofiber diameter is 5 nm to 20 nm, 15 nm to 25 nm, 20 nm to 30 nm, 25 nm to 35 nm, 30 nm to 40 nm, 35 nm to 45 nm, 40 nm to 50 nm, 45 nm to 55 nm, 50 nm to 60 nm, 55 nm to 65 nm, 60 nm to 70 nm, 65 nm to 75 nm, 70 nm to 80 nm, 75 nm to 85 nm, 80 nm to 90 nm, 85 nm to 95 nm, 90 nm to 100 nm, 95 nm to 105 nm, 100 nm to 110 nm, 105 nm to 115 nm, 110 nm to 120 nm, 115 nm to 125 nm, 120 nm to 130 nm, 125 nm to 135 nm, 130 nm to 140 nm, 135 nm to 145 nm, 140 nm to 150 nm, 145 nm to 155 nm, 150 nm to 160 nm, 155 nm to 165 nm, 160 nm to 170 nm, 165 nm to 175 nm, 170 nm to 180 nm, 175 nm to 185 nm, 180 nm to 190 nm, 185 nm to 195 nm, 190 nm to 200 nm, 195 nm to 205 nm, 200 nm to 210 nm, 205 nm to 215 nm, 210 nm to 220 nm, 215 nm to 225 nm, 220 nm to 230 nm, 225 nm to 235 nm, 230 nm to 240 nm, 235 nm to 245 nm, 240 nm to 250 nm, 245 nm to 255 nm, 250 nm to 260 nm, 255 nm to 265 nm, 260 nm to 270 nm, 265 nm to 275 nm, 270 nm to 280 nm, 275 nm to 285 nm, 280 nm to 290 nm, 285 nm to 295 nm, 290 nm to 300 nm, 295 nm to 305 nm, 300 nm to 310 nm, 305 nm to 315 nm, 310 nm to 320 nm, 315 nm to 325 nm, 320 nm to 330 nm, 325 nm to 335 nm, 330 nm to 340 nm, 335 nm to 345 nm, 340 nm to 350 nm, 345 nm to 355 nm, 350 nm to 360 nm, 355 nm to 365 nm, 360 nm to 370 nm, 365 nm to 375 nm, 370 nm to 380 nm, 375 nm to 385 nm, 380 nm to 390 nm, 385 nm to 395 nm, 390 nm to 400 nm, 395 nm to 405 nm, 400 nm to 410 nm, 405 nm to 415 nm, 410 nm to 420 nm, 415 nm to 425 nm, 420 nm to 430 nm, 425 nm to 435 nm, 430 nm to 440 nm, 435 nm to 445 nm, 440 nm to 450 nm, 445 nm to 455 nm, 450 nm to 460 nm, 455 nm to 465 nm, 460 nm to 470 nm, 465 nm to 475 nm, 470 nm to 480 nm, 475 nm to 485 nm, 480 nm to 490 nm, 485 nm to 495 nm, 490 nm to 500 nm, 500 nm to 550 nm, 525 nm to 575 nm, 550 nm to 600 nm, 575 nm to 625 nm, 600 nm to 650 nm, 625 nm to 675 nm, 650 nm to 700 nm, 675 nm to 725 nm, 700 nm to 750 nm, 725 nm to 775 nm, 750 nm to 800 nm, 775 nm to 825 nm, 800 nm to 850 nm, 825 nm to 875 nm, 850 nm to 900 nm, 925 nm to 975 nm, or 950 nm to 1000 nm on at least one layer. In yet further embodiments, the average fiber diameter is less than about 5 nm on at least one layer of the asymmetric nanofiber structure.

In some embodiments, the nanofibers, and/or the solution from which they are spun (or blown), comprise a polymer or a polymer blend. For example, in some embodiments the polymer or polymer blend is a semi-crystalline polymer. In some embodiments, the polymer or polymer blend is nylon-6, nylon-6,6, nylon 6,6-6,10, nylon-6 copolymers, nylon-6,6 copolymers, nylon 6,6-6,10 copolymers, and any mixture thereof. In certain embodiments, the polymer is nylon 6 or nylon 6,6. In some embodiments, the polymer is nylon 6,6.

In some embodiments, the polymer or polymer blend is selected from thermoplastic polymers, thermoset polymers, nylon, polyimide, aliphatic polyamide, aromatic polyamide, polysulfone, cellulose acetate, polyether sulfone, polyurethane, poly(urea urethane), polybenzimidazole, polyetherimide, polyacrylonitrile, poly(ethylene terephthalate), polypropylene, polyaniline, poly(ethylene oxide), poly(ethylene naphthalate), poly(butylene terephthalate), styrene butadiene rubber, polystyrene, poly(vinyl chloride), poly(vinyl alcohol), poly(vinylidene fluoride), poly(vinyl butylene) and copolymers, derivative compounds, or blends thereof. The term “nylon” as used herein may include nylon-6, nylon-6,6, nylon 6,6-6,10, and copolymers, derivative compounds, blends and combinations thereof.

In some embodiments, the polymer or polymer blend is selected from nylon-6, nylon-4,6, nylon-6,6, nylon 6,6-6,10, polyaramids, polyurethane (PU), polybenzimidazole, polycarbonate, polyacrylonitrile, polyvinyl alcohol, polylactic acid (PLA), polyethylene-co-vinyl acetate (PEVA), PEVA/PLA, polymethylmethacrylate (PMMA), PMMA/tetrahydroperfluorooctylacrylate (TAN), polyethylene oxide (PEO), collagen-PEO, polystyrene (PS), polyaniline (PANI)/PEO, PANI/PS, polyvinylcarbazole, polyethylene terephthalate (PET), polyacrylic acid-polypyrene methanol (PAA-PM), polyamide (PA), silk/PEO, polyvinylphenol (PVP), polyvinylchloride (PVC), cellulose acetate (CA), PAA-PM/PU, polyvinyl alcohol (PVA)/silica, polyacrylamide (PAAm), poly(lactic-co-glycolic acid) (PLGA), polycarprolactone (PCL), poly(2-hydroxyethyl methacrylate) (HEMA), poly(vinylidene difluoride) (PVDF), PVDF/PMMA, polyether imide (PEI), polyethylene glycol (PEG), poly(ferrocenyldimethylsilane) (PFDMS), Nylon6/montmorillonite (Mt), poly(ethylene-co-vinyl alcohol), polyacrylnitrile (PAN)/TiO2, polycaprolactone (PCL)/metal, polyvinyl porrolidone, polymetha-phenylene isophthalamide, polyethylene (PE), polypropylene (PP), nylon-12, polyethylene terephthalate (PET), polyethylene naphthalate (PEN), polyether sulfone (PES), polyvinyl butyral (PVB), PET/PEN, and copolymers, derivative compounds, or blends thereof.

The liquid filtration media disclosed herein may be made by electrospinning or electroblowing a polymer solution or melt to produce a porous, non-woven, polymeric nanofiber structure, such as a nanofiber mat. Preferably, liquid filtration media is made by electrospinning and the resultant porous, non-woven, polymeric nanofiber mat comprises one or more polymers. Electrospinning is process of producing nanofibers from a mixture of polymers, for example, polymer solution, suspension or polymer melt. The process involves applying an electric potential to such a polymer solution or polymer melt. Certain details of the electrospinning process for making an electrospun nanofiber mat or membrane, including suitable apparatuses for performing the electrostatic spinning process, are described in International Patent Application Publications WO2005/024101, WO2006/131081, and WO2008/106903, each of which is incorporated herein by reference in its entirety.

During electrospinning process, fibers are generated from a spinning electrode by applying a high voltage to the electrodes and a polymer solution where fibers are charged or spun toward a collecting electrode and collected as a highly porous non-woven mat on a substrate between the electrodes. In cases where the polymer solution discharged from the spinning nozzle is blown with a blowing gas discharged from a gas injection nozzle onto a substrate, it is referred to as electroblowing.

The disclosed nanofiber mat may have a thickness from about 1 μm to about 500 μm. In some embodiments, the nanofiber mat has a thickness of at least 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, 200 μm, 205 μm, 210 μm, 215 μm, 220 μm, 225 μm, 230 μm, 235 μm, 240 μm, 245 μm, 250 μm, 255 μm, 260 μm, 265 μm, 270 μm, 275 μm, 280 μm, 285 μm, 290 μm, 295 μm, 300 μm, 305 μm, 310 μm, 315 μm, 320 μm, 325 μm, 330 μm, 335 μm, 340 μm, 345 μm, 350 μm, 355 μm, 360 μm, 365 μm, 370 μm, 375 μm, 380 μm, 385 μm, 390 μm, 395 μm, 400 μm, 405 μm, 410 μm, 415 μm, 420 μm, 425 μm, 430 μm, 435 μm, 440 μm, 445 μm, 450 μm, 455 μm, 460 μm, 465 μm, 470 μm, 475 μm, 480 μm, 485 μm, 490 μm, 495 μm, or 500 μm.

In some embodiments, the produced nanofiber structure of the liquid filtration media disclosed herein (e.g., a nanofiber mat) has an average fiber diameter from about 5 nm to about 1,000 nm. The fiber diameter may have a wide distribution ranging 16-36% CoV. In some such embodiments, the average nanofiber diameter is no more than 1000 nm, 950 nm, 900 nm, 850 nm, 800 nm, 750 nm, 700 nm, 650 nm, 600 nm, 550 nm, 500 nm, 450 nm, 400 nm, 350 nm, 300 nm, 250 nm, 200 nm, 150 nm, 100 nm, 90 nm, 80 nm, 70 nm, 60 nm, 50 nm, 40 nm, 30 nm, or 20 nm. In some embodiments, the average nanofiber diameter is 5 nm to 20 nm, 15 nm to 25 nm, 20 nm to 30 nm, 25 nm to 35 nm, 30 nm to 40 nm, 35 nm to 45 nm, 40 nm to 50 nm, 45 nm to 55 nm, 50 nm to 60 nm, 55 nm to 65 nm, 60 nm to 70 nm, 65 nm to 75 nm, 70 nm to 80 nm, 75 nm to 85 nm, 80 nm to 90 nm, 85 nm to 95 nm, 90 nm to 100 nm, 95 nm to 105 nm, 100 nm to 110 nm, 105 nm to 115 nm, 110 nm to 120 nm, 115 nm to 125 nm, 120 nm to 130 nm, 125 nm to 135 nm, 130 nm to 140 nm, 135 nm to 145 nm, 140 nm to 150 nm, 145 nm to 155 nm, 150 nm to 160 nm, 155 nm to 165 nm, 160 nm to 170 nm, 165 nm to 175 nm, 170 nm to 180 nm, 175 nm to 185 nm, 180 nm to 190 nm, 185 nm to 195 nm, 190 nm to 200 nm, 195 nm to 205 nm, 200 nm to 210 nm, 205 nm to 215 nm, 210 nm to 220 nm, 215 nm to 225 nm, 220 nm to 230 nm, 225 nm to 235 nm, 230 nm to 240 nm, 235 nm to 245 nm, 240 nm to 250 nm, 245 nm to 255 nm, 250 nm to 260 nm, 255 nm to 265 nm, 260 nm to 270 nm, 265 nm to 275 nm, 270 nm to 280 nm, 275 nm to 285 nm, 280 nm to 290 nm, 285 nm to 295 nm, 290 nm to 300 nm, 295 nm to 305 nm, 300 nm to 310 nm, 305 nm to 315 nm, 310 nm to 320 nm, 315 nm to 325 nm, 320 nm to 330 nm, 325 nm to 335 nm, 330 nm to 340 nm, 335 nm to 345 nm, 340 nm to 350 nm, 345 nm to 355 nm, 350 nm to 360 nm, 355 nm to 365 nm, 360 nm to 370 nm, 365 nm to 375 nm, 370 nm to 380 nm, 375 nm to 385 nm, 380 nm to 390 nm, 385 nm to 395 nm, 390 nm to 400 nm, 395 nm to 405 nm, 400 nm to 410 nm, 405 nm to 415 nm, 410 nm to 420 nm, 415 nm to 425 nm, 420 nm to 430 nm, 425 nm to 435 nm, 430 nm to 440 nm, 435 nm to 445 nm, 440 nm to 450 nm, 445 nm to 455 nm, 450 nm to 460 nm, 455 nm to 465 nm, 460 nm to 470 nm, 465 nm to 475 nm, 470 nm to 480 nm, 475 nm to 485 nm, 480 nm to 490 nm, 485 nm to 495 nm, 490 nm to 500 nm, 500 nm to 550 nm, 525 nm to 575 nm, 550 nm to 600 nm, 575 nm to 625 nm, 600 nm to 650 nm, 625 nm to 675 nm, 650 nm to 700 nm, 675 nm to 725 nm, 700 nm to 750 nm, 725 nm to 775 nm, 750 nm to 800 nm, 775 nm to 825 nm, 800 nm to 850 nm, 825 nm to 875 nm, 850 nm to 900 nm, 925 nm to 975 nm, or 950 nm to 1000 nm. In yet further embodiments, the average fiber diameter is less than about 5 nm.

Two desirable features of a liquid filtration membrane are high permeability and reliable retention. In certain embodiments, the electrospun nanofiber media disclosed herein are highly porous polymeric materials, wherein the “pore” size is linearly proportional to the fiber diameter, while the porosity is relatively independent of the fiber diameter. In certain embodiments, the porosity of electrospun nanofiber media falls in the range of about 70% to 95% (e.g., about 75% to 95%, about 80% to 95%). In some embodiments, the electrospun nanofiber media provided herein has significantly higher permeability than immersion cast membranes having a similar thickness and pore size rating.

In some embodiments, the liquid filtration media provided herein (e.g., nanofiber mat) has a Bubble Point (BP) using Galwick® as wetting fluid (i.e., determined by a Bubble Point Test as set forth in ASTM Designation F316-03, “Standard Test Methods for Pore Size Characteristic of Membrane Filters by Bubble Point and Mean Flow Pore Test,” as reapproved in 2011) of 5 psi to 150 psi, e.g., 10 psi, 11 psi, 12 psi, 13 psi, 14 psi, 15 psi, 16 psi, 17 psi, 18 psi, 19 psi, 20 psi, 21 psi, 22 psi, 23 psi, 24 psi, 25 psi, 50 psi, 75 psi, 100 psi, 125 psi or 150 psi.

In some embodiments, the nanofiber structure (e.g., nanofiber mat) has a maximum pore size as determined by the bubble point test of no more than 500 nm, 450 nm, 400 nm, 350 nm, 300 nm, 250 nm 200 nm, 150 nm, 100 nm, or 50 nm. In some embodiments, the produced nanofiber structure (e.g., nanofiber mat) has a maximum pore size as determined by bubble point test of 5 nm to 20 nm, 15 nm to 25 nm, 20 nm to 30 nm, 25 nm to 35 nm, 30 nm to 40 nm, 35 nm to 45 nm, 40 nm to 50 nm, 45 nm to 55 nm, 50 nm to 60 nm, 55 nm to 65 nm, 60 nm to 70 nm, 65 nm to 75 nm, 70 nm to 80 nm, 75 nm to 85 nm, 80 nm to 90 nm, 85 nm to 95 nm, 90 nm to 100 nm, 95 nm to 105 nm, 100 nm to 110 nm, 105 nm to 115 nm, 110 nm to 120 nm, 115 nm to 125 nm, 120 nm to 130 nm, 125 nm to 135 nm, 130 nm to 140 nm, 135 nm to 145 nm, 140 nm to 150 nm, 145 nm to 155 nm, 150 nm to 160 nm, 155 nm to 165 nm, 160 nm to 170 nm, 165 nm to 175 nm, 170 nm to 180 nm, 175 nm to 185 nm, 180 nm to 190 nm, 185 nm to 195 nm, 190 nm to 200 nm, 195 nm to 205 nm, 200 nm to 210 nm, 205 nm to 215 nm, 210 nm to 220 nm, 215 nm to 225 nm, 220 nm to 230 nm, 225 nm to 235 nm, 230 nm to 240 nm, 235 nm to 245 nm, 240 nm to 250 nm, 245 nm to 255 nm, 250 nm to 260 nm, 255 nm to 265 nm, 260 nm to 270 nm, 265 nm to 275 nm, 270 nm to 280 nm, 275 nm to 285 nm, 280 nm to 290 nm, 285 nm to 295 nm, 290 nm to 300 nm, 295 nm to 305 nm, 300 nm to 310 nm, 305 nm to 315 nm, 310 nm to 320 nm, 315 nm to 325 nm, 320 nm to 330 nm, 325 nm to 335 nm, 330 nm to 340 nm, 335 nm to 345 nm, 340 nm to 350 nm, 345 nm to 355 nm, 350 nm to 360 nm, 355 nm to 365 nm, 360 nm to 370 nm, 365 nm to 375 nm, 370 nm to 380 nm, 375 nm to 385 nm, 380 nm to 390 nm, 385 nm to 395 nm, 390 nm to 400 nm, 395 nm to 405 nm, 400 nm to 410 nm, 405 nm to 415 nm, 410 nm to 420 nm, 415 nm to 425 nm, 420 nm to 430 nm, 425 nm to 435 nm, 430 nm to 440 nm, 435 nm to 445 nm, 440 nm to 450 nm, 445 nm to 455 nm, 450 nm to 460 nm, 455 nm to 465 nm, 460 nm to 470 nm, 465 nm to 475 nm, 470 nm to 480 nm, 475 nm to 485 nm, 480 nm to 490 nm, 485 nm to 495 nm, or 490 nm to 500 nm.

In some embodiments, the liquid filtration media (e.g., nanofiber mat) has a porosity of at least 70%, at least 75%, at least 80%, at least 85%, at least 90%, or at least 95%. In some embodiments, the porosity is 70% to 95%, 75% to 95%, 80% to 95%, 85% to 95% or 90% to 95%.

In some embodiments, the liquid filtration media (e.g., nanofiber mat) has a fiber diameter variation of no more than 30%, no more than 29%, no more than 28%, no more than 27%, no more than 26%, no more than 25%, no more than 24%, no more than 23%, no more than 22%, no more than 21%, no more than 20%, no more than 19%, no more than 18%, no more than 17%.

In some embodiments, the liquid filtration media (e.g., nanofiber mat) has a permeability of at least 10 LMH/psi to 20,000 LMH/psi. In some embodiments, the liquid filtration media (e.g., nanofiber mat) has a permeability of at least 10 LMH/psi to 20,000 LMH/psi. In some such embodiments, the liquid filtration media has a permeability of at least 6000 LMH/psi, at least 5750 LMH/psi, at least 5500 LMH/psi, at least 5250 LMH/psi, at least 5000 LMH/psi, at least 4750 LMH/psi, at least 4500 LMH/psi, at least 4250 LMH/psi, at least 4000 LMH/psi, at least 3750 LMH/psi, at least 3500 LMH/psi, at least 3250 LMH/psi, at least 3000 LMH/psi, at least 2750 LMH/psi, at least 2500 LMH/psi, at least 2250 LMH/psi, at least 2000 LMH/psi, at least 1750 LMH/psi, at least 1500 LMH/psi, at least 1250 LMH/psi, at least 1000 LMH/psi, at least 975 LMH/psi, at least 950 LMH/psi, at least 925 LMH/psi, at least 900 LMH/psi, at least 875 LMH/psi, at least 850 LMH/psi, at least 825 LMH/psi, at least 800 LMH/psi, at least 775 LMH/psi, at least 750 LMH/psi, at least 725 LMH/psi, at least 700 LMH/psi, at least 675 LMH/psi, at least 650 LMH/psi, at least 625 LMH/psi, at least 600 LMH/psi, at least 575 LMH/psi, at least 550 LMH/psi, at least 525 LMH/psi, at least 500 LMH/psi, at least 475 LMH/psi, at least 450 LMH/psi, at least 425 LMH/psi, at least 400 LMH/psi, at least 375 LMH/psi, at least 350 LMH/psi, at least 325 LMH/psi, or at least 300 LMH/psi or at least 100 LMH/psi, or at least 10 LMH/psi. In some embodiments, In some embodiments, the liquid filtration media has a permeability of at least 300 LMH/psi to at least 400 LMH/psi, at least 450 LMH/psi to at least 550 LMH/psi, at least 400 LMH/psi to at least 500 LMH/psi, at least 550 LMH/psi to at least 650 LMH/psi, at least 700 LMH/psi to at least 800 LMH/psi, at least 750 LMH/psi to at least 850 LMH/psi, at least 900 LMH/psi to at least 1000 LMH/psi, at least 850 LMH/psi to at least 950 LMH/psi, at least 1000 LMH/psi to at least 1050 LMH/psi, at least 1100 LMH/psi to at least 1200 LMH/psi, at least 1150 LMH/psi to at least 1250 LMH/psi, at least 1200 LMH/psi to at least 1300 LMH/psi, at least 1250 LMH/psi to at least 1350 LMH/psi, at least 1300 LMH/psi to at least 1400 LMH/psi, at least 1350 LMH/psi to at least 1450 LMH/psi, at least 1400 LMH/psi to at least 1500 LMH/psi, at least 1450 LMH/psi to at least 1550 LMH/psi, at least 1500 LMH/psi to at least 1600 LMH/psi, at least 1550 LMH/psi to at least 1650 LMH/psi, at least 1600 LMH/psi to at least 1700 LMH/psi, at least 1650 LMH/psi to at least 1750 LMH/psi, at least 1700 LMH/psi to at least 1800 LMH/psi, at least 1750 LMH/psi to at least 1850 LMH/psi, at least 1900 LMH/psi to at least 2000 LMH/psi, at least 1950 LMH/psi to at least 2050 LMH/psi, at least 2100 LMH/psi to at least 2200 LMH/psi, at least 2150 LMH/psi to at least 2250 LMH/psi, at least 2200 LMH/psi to at least 2300 LMH/psi, at least 2250 LMH/psi to at least 2350 LMH/psi, at least 2300 LMH/psi to at least 2400 LMH/psi, at least 2350 LMH/psi to at least 2450 LMH/psi, at least 2400 LMH/psi to at least 2500 LMH/psi, at least 2450 LMH/psi to at least 2550 LMH/psi, at least 2500 LMH/psi to at least 2600 LMH/psi, at least 2550 LMH/psi to at least 2650 LMH/psi, at least 2600 LMH/psi to at least 2700 LMH/psi, at least 2650 LMH/psi to at least 2750 LMH/psi, at least 2700 LMH/psi to at least 2800 LMH/psi, at least 2750 LMH/psi to at least 2850 LMH/psi, at least 2900 LMH/psi to at least 3000 LMH/psi, at least 2950 LMH/psi to at least 3050 LMH/psi, at least 3100 LMH/psi to at least 3200 LMH/psi, at least 3150 LMH/psi to at least 3250 LMH/psi, at least 3200 LMH/psi to at least 3300 LMH/psi, at least 3250 LMH/psi to at least 3350 LMH/psi, at least 3300 LMH/psi to at least 3400 LMH/psi, at least 3350 LMH/psi to at least 3450 LMH/psi, at least 3400 LMH/psi to at least 3500 LMH/psi, at least 3450 LMH/psi to at least 3550 LMH/psi, at least 3500 LMH/psi to at least 3600 LMH/psi, at least 3550 LMH/psi to at least 3650 LMH/psi, at least 3600 LMH/psi to at least 3700 LMH/psi, at least 3650 LMH/psi to at least 3750 LMH/psi, at least 3700 LMH/psi to at least 3800 LMH/psi, at least 3750 LMH/psi to at least 3850 LMH/psi, at least 3900 LMH/psi to at least 4000 LMH/psi, at least 3950 LMH/psi to at least 4050 LMH/psi, at least 4100 LMH/psi to at least 4200 LMH/psi, at least 4150 LMH/psi to at least 4250 LMH/psi, at least 4200 LMH/psi to at least 4300 LMH/psi, at least 4250 LMH/psi to at least 4350 LMH/psi, at least 4300 LMH/psi to at least 4400 LMH/psi, at least 4350 LMH/psi to at least 4450 LMH/psi, at least 4400 LMH/psi to at least 4500 LMH/psi, at least 4450 LMH/psi to at least 4550 LMH/psi, at least 4500 LMH/psi to at least 4600 LMH/psi, at least 4550 LMH/psi to at least 4650 LMH/psi, at least 4600 LMH/psi to at least 4700 LMH/psi, at least 4650 LMH/psi to at least 4750 LMH/psi, at least 4700 LMH/psi to at least 4800 LMH/psi, at least 4750 LMH/psi to at least 4850 LMH/psi, at least 4900 LMH/psi to at least 5000 LMH/psi, at least 4950 LMH/psi to at least 5050 LMH/psi, at least 5100 LMH/psi to at least 5200 LMH/psi, at least 5150 LMH/psi to at least 5250 LMH/psi, at least 5200 LMH/psi to at least 5300 LMH/psi, at least 5250 LMH/psi to at least 5350 LMH/psi, at least 5300 LMH/psi to at least 5400 LMH/psi, at least 5350 LMH/psi to at least 5450 LMH/psi, at least 5400 LMH/psi to at least 5500 LMH/psi, at least 5450 LMH/psi to at least 5550 LMH/psi, at least 5500 LMH/psi to at least 5600 LMH/psi, at least 5550 LMH/psi to at least 5650 LMH/psi, at least 5600 LMH/psi to at least 5700 LMH/psi, at least 5650 LMH/psi to at least 5750 LMH/psi, at least 5700 LMH/psi to at least 5800 LMH/psi, at least 5750 LMH/psi to at least 5850 LMH/psi, at least 5900 LMH/psi to at least 6000 LMH/psi, or at least 5950 LMH/psi, at least 6000 LMH/psi, at least 7000 LMH/psi, at least 8000 LMH/psi, at least 9000 LMH/psi, at least 10,000 LMH/psi, at least 12,000 LMH/psi, at least 14,000 LMH/psi, at least 16,000 LMH/psi, at least 18,000 LMH/psi, at least 20,000 LMH/psi.

A quantitative measure of microorganism retention by a filtration membrane is customarily expressed as a Log Reduction Value, sometimes referred to as a Log Retention Value or LRV. LRV is a logarithm of the ratio of particle concentration in the challenge solution to that in the filter effluent: LRV=Log {[CFU]_{challenge}/[CFU]_{effluent}}.

In the case when the filter retains all microorganisms under the conditions of the test, it is customarily to report the LRV as greater than the value obtained when a single microorganism passes the filter. For example, at the challenge particle concentration of 4.77×10⁷ CFU/cm², the maximum measurable LRV is 8.22 for a device with effective filtration area of 13.8 cm². When no particles pass the filter, the LRV is reported as greater than 8.22.

Pore size rating of a membrane is an indicator that the membrane has successfully passed a relevant, standardized bacterial challenge test. The most common pore size rating is 0.22 μm, which is assigned to membranes that pass a Standard Test Method for Determining Bacterial Retention of Membrane Filters Utilized For Liquid Filtration (ASTM F838-83 test), and can be validated to produce sterile effluent after being challenged with ≥10⁷ CFU/cm² Brevundimonas diminuta. Brevundimonas diminuta (ATTC #19146), formerly known as Pseudomonas diminuta, is an aerobic gram-negative bacteria (bacilli). Because of its small size, B. diminuta is a standard microbial organism for validation of membrane filters and the like for sterilization. Accordingly, the liquid filtration media disclosed herein have a log reduction value (LRV) of Brevundimonas diminuta of at least 1 as measured in accordance with ASTM F838-83. Alternatively, the liquid filtration media disclosed herein have a log reduction value (LRV) of Brevundimonas diminuta of at least 8 as measured in accordance with ASTM F838-83. Preferably, the liquid filtration media exhibit full retention of microorganisms, e.g., Brevundimonas diminuta as measured in accordance with ASTM F838-83. In certain embodiments, the liquid filtration media is challenged with viral particles and exhibits a virus log reduction value (LRV) greater than about 6. In certain other embodiments, the liquid filtration media disclosed herein is capable of purifying a biological material of interest, including virus-like particles, proteins, and conjugated polysaccharide as are found in vaccines. Generally biological materials having a molecular weight about or greater than 500 KDa. Thus, the liquid filtration media disclosed herein can exhibit retention of standardized macromolecules and/or particles of given sizes, such as in the use of dextrans in such standard methods as “dextran sieving”.

In some embodiments, the liquid filtration media (e.g., porous, non-woven, nanofiber-containing, liquid filtration media) further comprise a porous non-woven support. The nanofibers may be electrospun or electroblown onto a surface of the porous non-woven support, wherein the root mean square height of the surface of the porous non-woven support is less than about 70 μm. In some such embodiments, the support comprises one or more layers produced by melt-blowing, wet-laying, spun-bonding, calendaring, electrospinning, electro-blowing or any combination thereof. The support may comprise thermoplastic polymers, polyolefins, polypropylene, polyesters, polyamides, copolymers, polymer blends, or any combination thereof. Preferably, the tightest pore size of the nanofiber layer is smaller than the tightest pore size of the porous non-woven support.

In some embodiments, the porous support comprises one or more layers selected from the group consisting of spunbonded nonwovens, meltblown nonwovens, needle punched nonwovens, spunlaced nonwovens, wet laid nonwovens, resin-bonded nonwovens, electrospinning, electro-blowing, woven fabrics, knit fabrics, paper (including surface modified paper), and any combination thereof.

In some embodiments, provided herein are porous composite media comprising a porous asymmetric polyethersulfone (PES) flat sheet membrane prefilter, and a retentive layer comprising a liquid filtration medium prepared by any of the methods disclosed herein. In some embodiments, the porous asymmetric PES flat sheet membrane prefilter has a tight layer and an open layer and a pore size increasing in size between the tight layer and the open layer. Said retentive layer comprising the liquid filtration medium disclosed herein may be disposed on the tight layer of the porous asymmetric PES flat sheet membrane. In preferred embodiments, the pore size of the retentive layer is smaller than the pore size of the tight layer of the porous asymmetric PES flat sheet membrane prefilter. In some such embodiments, the porous composite media has a bubble point, as measured with a liquid, which is at least 20% greater than the bubble point of the porous flat sheet membrane prefilter alone. Preferably, the porous composite media has a mean flow bubble point for isopropanol ranging from about 10 psi to about 130 psi. In some embodiments, the porous asymmetric PES flat sheet membrane disclosed herein comprises one or more layers produced by solution phase inversion, thermally initiated phase separation, vapor induced phase separation, track etching, biaxial stretching, solvent etching, and combinations thereof. Accordingly, provided herein are filtration devices for use in critical filtration comprising such porous composite media as disclosed herein. In such critical filtration devices, the porous asymmetric PES flat sheet membrane may provide prefiltration of the sample while the retentive filter layer provides further filtration of said sample. In some such embodiments, the porous composite filtration media is preferably positioned such that the porous asymmetric PES flat sheet membrane is upstream, in the direction of filtration, of the retentive filter layer.

Notably, the liquid filtration media disclosed herein (e.g., heat-treated, porous, non-woven, asymmetric, polymer nanofiber-containing, liquid filtration media) are compatible with moist heat sterilization. Moist heat is typically used in connection with aseptic applications as are commonly practiced in the biopharmaceutical industry, for example. Such impact of wet-dry processes including moist heat sterilization methods as are known in the art include, but are not limited to, flowing saturated steam under pressure (i.e., steam-in-place sterilization), autoclave sterilization, and tyndallization. Preferably, the liquid filtration media are compatible with autoclave sterilization such that they resist changes in nanofiber structure (e.g., nanofiber morphology) and filtration parameters (e.g., permeability, porosity, LRV, and BP) described herein.

In some embodiments, the liquid filtration medium provided herein resist changes in liquid permeability post-sterilization relative to a corresponding filtration medium that does not comprise semi-crystalline polymer nanofibers, that does not comprise an asymmetric nanofiber structure, that has not been heat-treated, or any combination thereof. In some such embodiments, the sterilized liquid filtration medium exhibits no more than a 15% reduction in liquid permeability post-sterilization. For example, the autoclaved liquid filtration media of the invention (e.g., autoclaved at least once or up to at least 12 times) exhibit no change in liquid permeability. Preferably, such sterilized liquid filtration media exhibit no more than a 1% to 15% reduction in liquid permeability, such as a 1%, 2%, 3%, 4%, 5%, 6%, 7%, 8%, 9%, 10%, 11%, 12%, 13%, 14%, or 15%, reduction in liquid permeability. More preferably, the disclosed sterilized liquid filtration media exhibit no more than an 11% reduction in liquid permeability. In most preferred embodiments, the sterilized liquid filtration media (e.g., autoclaved at least once or up to at least 12 times) exhibit an increase in liquid permeability, such as at least a 1% to 6% increase in liquid permeability. Preferably, the sterilized liquid filtration media exhibit an increase in liquid permeability of at least 6%.

Likewise, the sterilized liquid filtration media (e.g., autoclaved at least once or up to at least 12 times) resist changes in Bubble Point (BP) as disclosed herein. In some such embodiments sterilized liquid filtration media exhibit no change in BP. For example, and without limitation, the sterilized liquid filtration media exhibit or maintain a BP of 5 psi to 150 psi. Preferably, the sterilized liquid filtration medium exhibits or maintains a bubble point of 20 psi or greater. Most preferably, the liquid filtration medium exhibits less change in BP post-sterilization compared to a corresponding filtration medium that does not comprise semi-crystalline polymer nanofibers, that does not comprise an asymmetric nanofiber structure, that has not been heat-treated, or any combination thereof. In some such embodiments the BP is measured with water. In preferred embodiments the BP is measured with an alcohol (e.g., ethanol and/or isopropyl alcohol). In more preferred embodiments, the BP is measured with a solution comprising water and alcohol. Most preferably, BP is measured with Galwick® wetting fluid.

In some embodiments, the sterilized liquid filtration media (e.g., autoclaved at least once or up to at least 12 times) resist changes in porosity. Preferably, such sterilized liquid filtration media exhibit or maintain a porosity from about 80% to about 95%.

In some embodiments, the sterilized liquid filtration media (e.g., autoclaved at least once or up to at least 12 times) has or maintains its log reduction value (LRV). In preferred embodiments the sterilized liquid filtration media has an LRV of Brevundimonas diminuta of at least 8 as measured in accordance with ASTM F838-83. More preferably, the sterilized liquid filtration media exhibit full retention of microorganisms.

In further aspects of the invention, disclosed herein are methods of removing bacteria from a liquid sample comprising heating a porous, non-woven, polymeric nanofiber-containing liquid filtration medium disclosed herein to at least the T_{g} but no more than the Tₘ of the polymeric nanofibers, as disclosed herein. For example, the heat treatment may be conducted for at least 1 hour, and preferably in a non-oxidizing environment, such as an inert-atmosphere oven. The heat-treated liquid filtration medium is then sterilized using moist heat sterilization, such as autoclave sterilization and the liquid sample containing bacteria is passed through the sterilized liquid filtration medium. In preferred embodiments, the liquid filtration media exhibits a log reduction value (LRV) of Brevundimonas diminuta of at least 8 as measured in accordance with ASTM F838-83 before and/or after autoclave sterilization.

Similarly, certain aspects of the invention include methods of removing viral particles from liquid samples, said methods comprising heating a porous, non-woven, polymeric nanofiber-containing liquid filtration medium disclosed herein to at least the T_{g} but no more than the Tₘ of the polymeric nanofibers, as disclosed herein. For example, such heat treatment may be conducted for at least 1 hour, and preferably in a non-oxidizing environment, such as an inert-atmosphere oven. Likewise, heat treated liquid filtration medium is then sterilized using moist heat sterilization, such as autoclave sterilization, and the liquid sample containing the viral particles is passed through the sterilized liquid filtration medium. In some such embodiments, the liquid filtration medium exhibits a virus log reduction value (LRV) greater than about 6 before and/or after autoclave sterilization.

Test Methods

When reported herein, basis weight is determined according to ASTM procedure D-3776/D3776M-09a (2017), “Standard Test Methods for Mass Per Unit Area (Weight) of Fabric,” and reported in g/m².

When reported herein, porosity is calculated by dividing the basis weight of the sample in g/m² by the polymer density in g/cm³, by the sample thickness in micrometers, multiplying by 100, and subtracting the resulting number from 100, i.e., % porosity=100−[basis weight/(density×thickness)×100].

When reported herein, fiber diameter is determined as follows: A scanning electron microscope (SEM) image was taken at (e.g., at 20,000, 40,000 or 60,000 times magnification) of each layer of nanofiber mat sample. The diameter of at least ten (10) clearly distinguishable nanofibers are measured from each SEM image and recorded. Irregularities were not included in determining fiber diameter (i.e., lumps of nanofibers, polymer drops, intersections of nanofibers, etc.).

When reported herein, nanofiber mat thickness is determined according to ASTM procedure 01777-96, “Standard Test Method for Thickness of Textile Materials,” and is reported in nanometers (nm) or micrometers (μm).

When reported herein, maximum pore size is determined by bubble point test as set forth in ASTM Designation F316-03, “Standard Test Methods for Pore Size Characteristic of Membrane Filters by Bubble Point and Mean Flow Pore Test”, as reapproved in 2011, and is reported in nanometers (nm).

When reported herein, bacterial Log Retention Value (LRV) is determined according to the standard test methods of ASTM F838-83, “Standard Test Method for Determining Bacterial Retention of Membrane Filters Utilized For Liquid Filtration”.

Unless otherwise stated, all BP are measured with Galwick® (Porous Materials Incorporated, Ithaca, N.Y.) as the wetting fluid.

### EXEMPLIFICATION

### Example 1

A study was conducted to upgrade as-spun, electrospun nanofiber mats (starting material) to an autoclave-sterilizable type using a unique combination of qualities selected from structure, material and process.

Four types of nanofiber mat were tested; each using a method comprising electrospinning a polymer solution from the spinning electrode onto a non-woven substrate (i.e., using manufacturing-scale electrospinning equipment). The properties of said mats were reported immediately after production without any modification (referred to herein throughout as ‘as-spun’ characterization).

Table 2 describes four nanofiber mats and their pertinent properties. All selected membranes had a fiber diameter close to 100 nm on, at least, one layer of the filter mat such that the filtration medium exhibited full retention of Brevundimonas diminuta by size-based separation, as measured in accordance with ASTM F838-83. Moreover, all membranes exhibited a porosity ranging from 85-95%, a Galwick® bubble point of at least 15 psi (psig) (considered adequate for full retention), and a liquid permeability of greater than 3000 LMH/psi. The maximum pore size of nanofiber mats is determined by bubble point test as set forth in ASTM Designation F316-03 and using Galwick® as the wetting fluid.

TABLE 2
Four different nanofiber membranes were selected which
include two different materials (nylon 6 and nylon 66)
and two different structures (symmetric vs asymmetric).

| | | | SEM fiber | Water | |
|---|---|---|---|---|---|
| | Bubble | | dia., nm | Perm., | |
| Membrane | Point, | Po- | (downstream/ | LMH/ | Retention |
| Type | psi | rosity | upstream) | psi | (B. diminuta) |
| Symmetric-N6 | 18 | 85% | 95/95 | 4575 | >10⁷ cfu/cm² |
| Asymmetric- | 18 | 90% | 103/127 | 5254 | >10⁷ cfu/cm² |
| N6 | | | | | |
| Symmetric- | 16 | 89% | 106/109 | 3601 | >10⁷ cfu/cm² |
| N66 | | | | | |
| Asymmetric- | 17 | 90% | 93/153 | 3226 | >10⁷ cfu/cm² |
| N66 | | | | | |

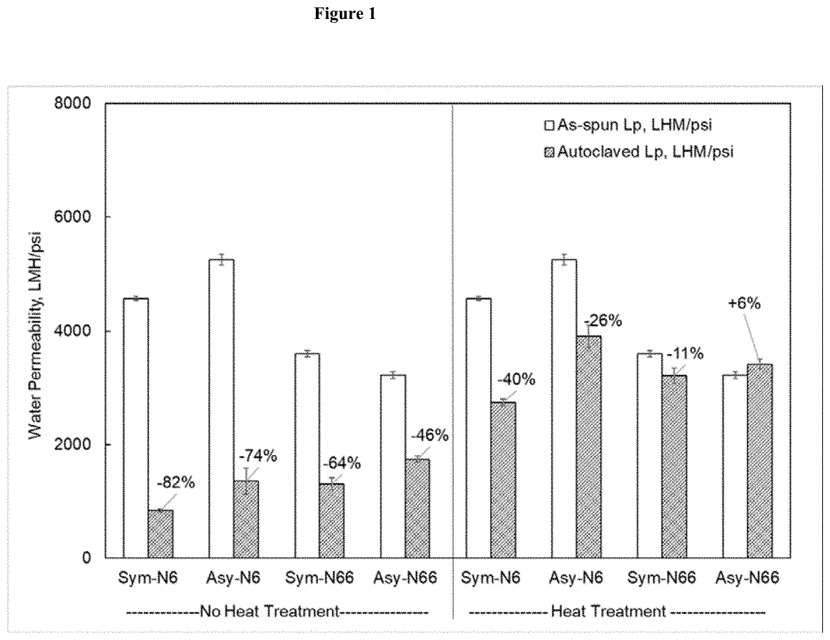

The nanofiber mat types (as described in Table 2) were categorized as either ‘no heat treatment’ (see FIG. 1, left panel) or ‘heat treatment’ (see FIG. 1, right panel). The heat treatment step included heating the nanofiber mat rolls in a non-oxidizing environment (e.g., in anaerobic/inert atmosphere ovens) for up to 12 hours at 208° C.

Prior to autoclaving (or heat-treatment and autoclaving), all nanofiber membranes described in Table 2 were subjected to an additional wetting-drying step which included wetting in water or isopropyl-water solution and drying at 80° C. for 12 hours. Typically, filtration devices (e.g., industrially applied filtration devices) undergo a wet-dry process during integrity testing before reaching the customer's site, where it is sterilized prior to application. Thus, the inclusion of such a step ensured that all possible impact of drying had been accounted.

Autoclaving was conducted under aggressive conditions which included heating up to one or more cycles of 135° C. for 60 minutes, followed by 15 minutes of drying time. In general, such autoclaving parameters exceed industrially practiced sterilization procedures, which are typically conducted at 126° C.

Results

The sterilization process resulted in significant (and expected) reductions in water permeability across all untreated mat types (see FIG. 1, left panel, comparing white to cross-hatched bars). Notably, polymers, when used to produce nanofibers, undergo molecular scission during the polymer dissolution step due to the use of strong solvents and the elevated temperature (80° C. for 6 hours) required by the electrospinning process. It is possible that the electrospinning process itself is contributing to molecular chain degradation by electrostatic forces. The intrinsic viscosity of nanofiber polymer is significantly lower than that of native polymer, which is indicative of the detrimental effect of solvent and the electrospinning process on fiber strength. Further degradation occurs in the autoclave, under a high-heat and humid environment. This bears similarity to the phenomenon commonly referred to as hydrolytic instability (i.e., the lack of resistance of a cured polymer material to reverting to a semisolid or liquid form when exposed to high humidity and temperature).

In contrast, most nanofiber mats that received heat treatment prior to autoclaving showed markedly smaller reductions in water permeability; with the notable exception of heat-treated, asymmetric vs symmetric, nanofiber mats of nylon-66, which actually showed an improvement in water permeability (see, FIG. 1, right panel, “Asymmetric-N66” in particular).

Solid state polymerization can occur within condensation polymers, such as nylon, where solid pre-polymers (as well as dry monomers) follow step-growth chemistry using end-group functionality, resulting in higher molecular weights. Without wishing to be bound by any particular theory, the heat treatment may boost molecular weight using solid state condensation. The solid pre-polymer crystals react at a temperature lower than the melting point (Tₘ) under inert gas (i.e., a non-oxidizing environment) and convert single-monomer crystals into highly-oriented polycrystalline polymer aggregates. The increase in molecular weight of the polymer by heat treatment was confirmed by zero-shear melt viscosity data, which is known to correlate with average molecular weight of polymeric materials. In addition, the heat treatment step was found to improve the polymer crystallinity as evidenced by differential scanning calorimetry (DSC) thermogram. Both molecular weight and crystallinity impact the strength of the nanofiber mat. It should be noted that ‘wettability’ of the nanofiber mats, before and after heat treatment, remained unchanged.

Such data suggest that alteration of the mechanical properties of the nanofiber mat are responsible for the observed robustness.

### Example 2

In order to understand the significance of the combination of structure, polymer material, and process (e.g., asymmetric vs symmetric, N66, and heat-treatment) and their relative contribution in mitigating permeability loss, the following analyses were conducted. Table 3 describes the layout of the experimental design, sorted first by ‘process’, then by ‘material’, followed by ‘structure’. The effects of each factor, and combination factors, on loss of water permeability (as illustrated in FIG. 1) were then evaluated. Notably, just by instituting this type of sorting order the nanofiber mats are automatically arranged by the observed loss in water permeability in ascending order, indicating the differences in relative contribution of these parameters (see, ‘output’ column of Table 3).

TABLE 3
Design of Experiment to understand the critical parameter

| | | Parameters | | | | |
|---|---|---|---|---|---|---|
| | | Process: Heat | | | | Output-2: |
| | | Treatment | | | Output-1: | Bubble Point |
| | | Heat | Material: | | Water | Pressure |
| | | Treat (+) | Polymer | Symmetry | Permeability | % Change |
| | | vs No Heat | N66 (+) | Asymmetric (+) | % Perm. | in BP |
| Order | Mat Type | Treat (−) | vs N6 (−) | vs Symmetric (−) | Loss | pressure, |
| 1 | Symmetric -N6 | − | − | − | −82 | 125 |
| 2 | Asymmetric-N6 | − | − | + | −74 | 113 |
| 3 | Symmetric -N66 | − | + | − | −64 | 85 |
| 4 | Asymmetric -N66 | − | + | + | −46 | 65 |
| 5 | Symmetric -N6 | + | − | − | −40 | 52 |
| 6 | Asymmetric-N6 | + | − | + | −26 | 47 |
| 7 | Symmetric -N66 | + | + | − | −11 | 36 |
| 8 | Asymmetric-N66 | + | + | + | 6 | 24 |

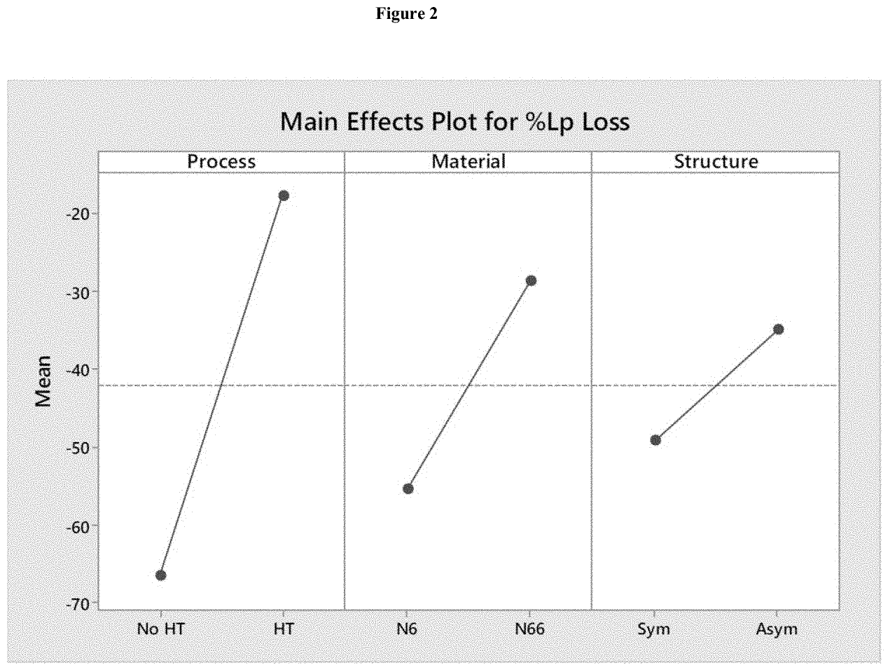

Using a Main Effects Plot (see FIG. 2), the mean response values at each process parameter were compared to the relative strength of the effects of the various factors of the experiment. Briefly, when the line is horizontal (parallel to the x-axis), there is no main effect; each level of the factor affects the response in the same way, and the response mean % Permeability loss is the same across all factor levels. However, when the line is not horizontal, then that factor affects the outcome (i.e., permeability). Different levels of the factor affect the response differently. In addition, the steeper the slope of the line, the greater the magnitude of the main effect. FIG. 2 clearly shows that in terms of impact, the following order is evident: Process >Material >Structure. Additional analysis confirmed that all three effects have statistically significant influence on the permeability loss.

### Example 3

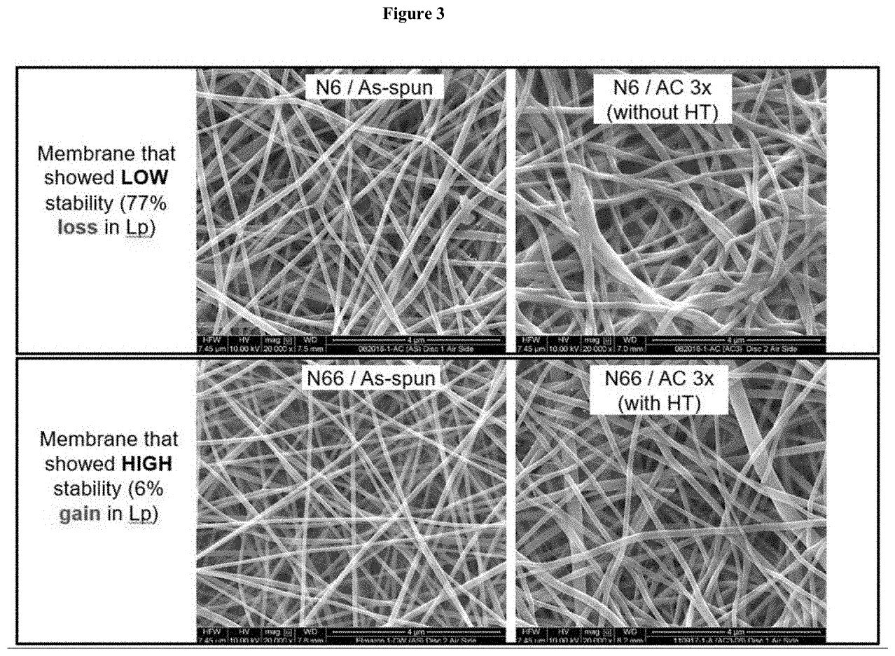

The morphology of asymmetric nanofiber mats were also studied by scanning electron microscopy (SEM) and the said asymmetric mats were subjected to at least 3 rounds of autoclaving (AC 3×). The mat comprising nylon-6 (N6) and processed without heat treatment showed the most drastic change in structure. The SEM micrographs of FIG. 3 show that the fibers that were oriented in straight arrays prior to sterilization appeared to become wavy and comprise more fusions at fiber intersections (see upper panels). On the other end, nylon-66 (N66) nanofiber with heat treatment do not show significant morphological differences pre- and post-sterilization (see lower panels) and is consistent with the observed mat robustness as evidenced by minimal loss (if any) in water permeability.

### Example 4

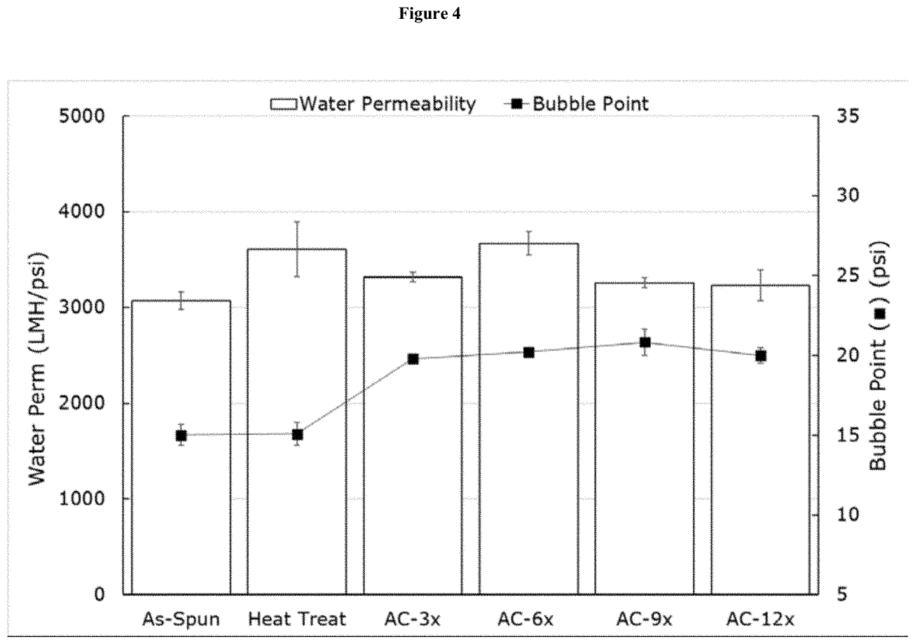

The heat-treated asymmetric N66 nanofiber mat, with its notable improvement in water permeability, was subjected to more than 3 cycles of autoclave sterilization. With all three factors in place (heat treatment, nylon-66, and asymmetry), the nanofiber mat sufficiently robust to withstand up to 12 autoclave cycles and did not show any significant negative affect on water permeability (see, FIG. 4). In addition to the observed improvement in water permeability, the Bubble point (or BP; using Galwick® as wetting fluid), which is a measure of mat's retention property, increases after the first 3 cycles of autoclave sterilization and remains consistent on subsequent autoclave cycles. Such increases in BP provide additional assurance on mat retention behavior.

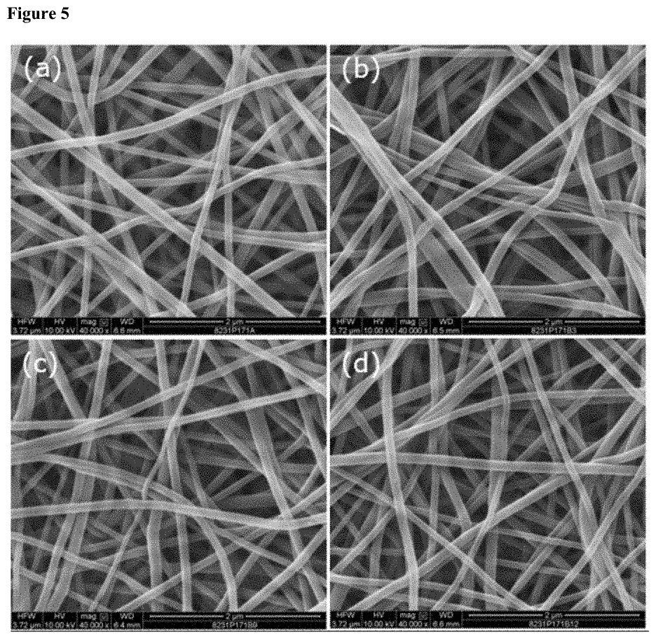

Furthermore, multiple autoclave cycles appeared to have little impact on nanofiber morphology in the best-performing mats (i.e., heat-treated, asymmetric, nylon-66 mats), even by 12 autoclave cycles (12×AC) (see FIG. 5). The data suggest that heat-treated, asymmetric N66 mats are robust in the face of moist-heat sterilization. Such nanofiber mats show no drop to modest improvement in water permeability after as many as 12 autoclave cycles.

### INCORPORATION BY REFERENCE

All publications, patents, and patent applications mentioned herein are hereby incorporated by reference in their entirety as if each individual publication, patent or patent application was specifically and individually indicated to be incorporated by reference. In case of conflict, the present application, including any definitions herein, will control.

### EQUIVALENTS

Those skilled in the art will recognize or be able to ascertain using no more than routine experimentation, many equivalents to the specific embodiments described herein. Such equivalents are intended to be encompassed by the following claims.

What is claimed is:

1. A method for producing a porous, non-woven, polymeric nanofiber-containing, liquid filtration medium, the method comprising heating the porous, non-woven, nanofiber-containing liquid filtration medium to at least the glass transition temperature (T_{g}) but no more than the melting temperature (Tₘ) of the nanofibers for at least 1 hour.

2. The method of claim 1, wherein the liquid filtration medium is made by electrospinning a polymer solution or melt to produce a porous, non-woven, polymeric nanofiber mat.

3. The method of claim 1, wherein the liquid filtration medium resists changes in liquid permeability post-sterilization relative to a corresponding filtration medium that has not been heated to at least the glass transition temperature (T_{g}) but no more than the melting temperature (Tₘ) of the nanofibers for at least 1 hour prior to sterilization.

4. The method of claim 1, wherein the liquid filtration medium exhibits a bubble point pressure of 5 psi to 150 psi.

5. The method of claim 1, wherein the liquid filtration medium exhibits a log reduction value (LRV) of Brevundimonas diminuta of at least 1 as measured in accordance with ASTM F838-83.

6. The method of claim 1, wherein the liquid filtration medium has a porosity from about 80% to about 95%.

7. The method of claim 1, wherein the liquid filtration medium exhibits a liquid permeability greater than about 1000 LMH/psi.

8. The method of claim 1, wherein the liquid filtration medium exhibits no more than a 40% reduction in liquid permeability post-sterilization.

9. The method of claim 1, wherein the nanofibers have a fiber diameter from about 5 nm to about 1,000 nm.

10. The method of claim 1, wherein the liquid filtration medium comprises either 1) a symmetric nanofiber mat or 2) an asymmetric nanofiber mat that exhibits a varying fiber diameter across the thickness of nanofiber mat such that the mean fiber diameter of one layer of the nanofiber mat is different than the other layers of nanofiber mat.

11. The method of claim 10, wherein the mean fiber diameter changes continuously from one layer of the asymmetric nanofiber mat to the other layer.

12. The method of claim 10, wherein the ratio of mean fiber diameter of one layer of the asymmetric nanofiber mat to the other layer is at least 1.15.

13. The method of claim 10, wherein the mean fiber diameter is about 5 nm to about 1,000 nm on at least one layer of the asymmetric nanofiber mat.

14. The method of claim 2, wherein the polymer is selected from: thermoplastic polymers, thermoset polymers, nylon, polyimide, aliphatic polyamide, aromatic polyamide, polysulfone, cellulose acetate, polyether sulfone, polyurethane, poly(urea urethane), polybenzimidazole, polyetherimide, polyacrylonitrile, poly(ethylene terephthalate), polypropylene, polyaniline, poly(ethylene oxide), poly(ethylene naphthalate), poly(butylene terephthalate), styrene butadiene rubber, polystyrene, poly(vinyl chloride), poly(vinyl alcohol), poly(vinylidene fluoride), poly(vinyl butylene) and copolymers, derivative compounds, or blends thereof.

15. The method of claim 14, wherein the polymer is aliphatic polyamide.

16. The method of claim 14, wherein the polymer is selected from: nylon-6, nylon-6,6, nylon 6,6-6,10, nylon-6 copolymers, nylon-6,6 copolymers, nylon 6,6-6,10 copolymers, and any mixture thereof.

17. The method of claim 14, wherein the polymer is nylon-6,6.

18. The method of claim 1, comprising heating the nanofiber mat from about 1° C. to about 80° C. below Tₘ.

19. The method of claim 18, comprising heating the nanofiber mat to about 56° C. below Tₘ.

20. The method of claim 18, comprising heating the nanofiber mat to about 75° C. below Tₘ.

21. The method of claim 1, comprising heating the nanofiber mat by about 100° C. to about 200° C. above T_{g}.

22. The method of claim 1, comprising heating the nanofiber mat in a non-oxidizing environment such as in an inert atmosphere oven.

23. The method of claim 1, comprising heating the nanofiber mat for at least about 1 hour to at least about 24 hours.

24. The method of claim 1, wherein the porous, non-woven, nanofiber-containing, liquid filtration medium is electrospun onto a surface of the porous or non-porous support.

25. A liquid filtration media made by the method of claim 1.

26. A liquid filtration device comprising the liquid filtration media of claim 25.
